(19) United States
(12) Patent Application Publication
(10) Pub. No.: US 2025/0219447 A1
(43) Pub. Date: Jul. 3, 2025

(54) TECHNIQUES FOR PERFORMING PASSIVE INTERNET OF THINGS COMMUNICATIONS

(71) Applicant: QUALCOMM Incorporated, San Diego, CA (US)

(72) Inventors: Zhikun WU, Beijing (CN); Yuchul KIM, San Diego, CA (US); Ahmed ELSHAFIE, San Diego, CA (US); Linhai HE, San Diego, CA (US); Seyedkianoush HOSSEINI, San Diego, CA (US); Huilin XU, Temecula, CA (US); Yu ZHANG, San Diego, CA (US)

(21) Appl. No.: 18/851,024

(22) PCT Filed: May 13, 2022
(86) PCT No.: PCT/CN2022/092610

§ 371 Date: Sep. 25, 2024

(51) Int. Cl. H02J 50/00; H02J 50/20; H04W 72/044; H04W 72/23

(52) U.S. Cl. CPC H02J 50/001; H02J 50/20; H04W 72/044; H04W 72/23

(57) ABSTRACT

Methods, systems, and devices for wireless communications are described. A user equipment (UE) may receive, from a network entity, a grant that allocates a set of resources for use by the UE. Additionally, the UE may explicitly or implicitly receive an indication that the grant received at the UE pertains to communications between the UE and an energy-harvesting device (e.g., passive internet of things (IoT) communications with an energy-harvesting device), where the communications include at least one of an energy-providing transmission to the energy-harvesting device, a data transmission to the energy-harvesting device, or a data reception from the energy-harvesting device. In accordance with the grant, the UE may communicate with the energy-harvesting device.

### CROSS REFERENCE

The present Application is a 371 national stage filing of International PCT Application No. PCT/CN2022/092610 by WU et al. entitled “TECHNIQUES FOR PERFORMING PASSIVE INTERNET OF THINGS COMMUNICATIONS,” filed May 13, 2022, which is assigned to the assignee hereof, and which is expressly incorporated by reference in its entirety herein.

### FIELD OF TECHNOLOGY

The following relates to wireless communications, including techniques for performing passive internet of things communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support communications between an energy transmitter device and an energy-harvesting device. The energy-harvesting device may harvest energy from an energy signal transmitted by the energy transmitter device in order to gain enough power to exchange signals with the energy transmitter device. Techniques for supporting an energy-harvesting device may be improved.

### SUMMARY

The described techniques relate to improved methods, systems, devices, and apparatuses that support techniques for performing passive internet of things communications. Generally, the techniques described herein provide methods for allocating resources for passive IoT communications in a wireless communications system. For example, a user equipment (UE) may receive, from a network entity, a grant that allocates a set of resources for use by the UE. Additionally, the UE may receive an indication (e.g., implicitly, or explicitly) that the grant received at the UE pertains to communications between the UE and an energy-harvesting device. The communications between the UE and the energy-harvesting device may include an energy-providing transmission to the energy-harvesting device (e.g., transmitted by the UE, or a network entity), data reception from the energy-harvesting device, data transmission to the energy-harvesting device, or a combination thereof. The UE may communicate with the energy-harvesting device in accordance with the grant.

A method for wireless communications at a UE is described. The method may include receiving, from a network entity, a grant that allocates a set of resources for use by the UE, receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device, and communicating with the energy-harvesting device in accordance with the grant.

An apparatus for wireless communications at a UE is described. The apparatus may include a processor, memory coupled with the processor, and instructions stored in the memory. The instructions may be executable by the processor to cause the apparatus to receive, from a network entity, a grant that allocates a set of resources for use by the UE, receive an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device, and communicate with the energy-harvesting device in accordance with the grant.

Another apparatus for wireless communications at a UE is described. The apparatus may include means for receiving, from a network entity, a grant that allocates a set of resources for use by the UE, means for receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device, and means for communicating with the energy-harvesting device in accordance with the grant.

A non-transitory computer-readable medium storing code for wireless communications at a UE is described. The code may include instructions executable by a processor to receive, from a network entity, a grant that allocates a set of resources for use by the UE, receive an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device, and communicate with the energy-harvesting device in accordance with the grant.

In some examples of the method, apparatuses, and non-transitory computer-readable medium described herein, receiving the indication may include operations, features, means, or instructions for receiving a message that explicitly indicates that the grant pertains to the communications between the UE and the energy-harvesting device, where the message may be a radio resource control (RRC) message, a medium access control (MAC) control element (MAC-CE) message, or downlink control information (DCI) message.

In some examples of the method, apparatuses, and non-transitory computer-readable medium described herein, receiving the indication may include operations, features, means, or instructions for receiving a message indicative of a set of multiple resources dedicated for energy-harvesting communications and identifying that the grant pertains to the communications between the UE and the energy-harvesting device based on the set of multiple resources including the set of resources.

Some examples of the method, apparatuses, and non-transitory computer-readable medium described herein may further include operations, features, means, or instructions for receiving a message indicating a time range, a frequency range, or a combination thereof for which the grant may be applicable, where the set of resources may be within the time range, the frequency range, or the combination thereof.

In some examples of the method, apparatuses, and non-transitory computer-readable medium described herein, the message may be an RRC message, a MAC-CE message, or DCI message.

In some examples of the method, apparatuses, and non-transitory computer-readable medium described herein, the set of resources pertaining to the communications between the UE and the energy-harvesting device includes a duration greater than 14 symbols.

Some examples of the method, apparatuses, and non-transitory computer-readable medium described herein may further include operations, features, means, or instructions for receiving, from the network entity, a second grant that allocates a second set of resources for the communications between the UE and the energy-harvesting device and receiving a message indicating a time range, a frequency range, or a combination thereof for which the grant and the second grant may be applicable, where the set of resources and the second set of resources may be within the time range, the frequency range, or the combination thereof.

In some examples of the method, apparatuses, and non-transitory computer-readable medium described herein, the set of resources and the second set of resources may be adjacent in the time range.

In some examples of the method, apparatuses, and non-transitory computer-readable medium described herein, a set of frequency resources of the set of resources may be different from a second set of frequency resources of the second set of resources.

In some examples of the method, apparatuses, and non-transitory computer-readable medium described herein, the message may be an RRC message, a MAC-CE message, or DCI message.

Some examples of the method, apparatuses, and non-transitory computer-readable medium described herein may further include operations, features, means, or instructions for receiving a message indicating whether the UE may be to transmit the energy-providing transmission to the energy-harvesting device to power on the energy-harvesting device.

In some examples of the method, apparatuses, and non-transitory computer-readable medium described herein, the set of resources include one or more uplink-configured slots, one or more downlink-configured slots, or a combination thereof for the communications between the UE and the energy-harvesting device.

In some examples of the method, apparatuses, and non-transitory computer-readable medium described herein, communicating with the energy-harvesting device may include operations, features, means, or instructions for transmitting, to the energy-harvesting device, the energy-providing transmission to power on the energy-harvesting device in accordance with the grant, where the UE transmits the energy-providing transmission in a downlink configured slot, or an uplink configured slot, or both.

In some examples of the method, apparatuses, and non-transitory computer-readable medium described herein, the UE transmits the energy-providing transmission to the energy-harvesting device in one or more resources of the set of resources adjacent to a data signal transmitted to or received from the energy-harvesting device.

In some examples of the method, apparatuses, and non-transitory computer-readable medium described herein, communicating with the energy-harvesting device may include operations, features, means, or instructions for receiving, from the energy-harvesting device, a data signal in accordance with the grant, where the UE receives the data signal in a downlink configured slot, an uplink configured slot, or both.

In some examples of the method, apparatuses, and non-transitory computer-readable medium described herein, communicating with the energy-harvesting device may include operations, features, means, or instructions for transmitting, to the energy-harvesting device, a data signal in accordance with the grant, where the UE transmits the data signal in a downlink configured slot, an uplink configured slot, or both.

In some examples of the method, apparatuses, and non-transitory computer-readable medium described herein, the grant may be an uplink grant or a downlink grant pertaining to the communications between the UE and the energy-harvesting device.

In some examples of the method, apparatuses, and non-transitory computer-readable medium described herein, the UE communicates with the energy-harvesting device in accordance with time division duplexing, frequency division duplexing, or a combination thereof.

A method for wireless communications at a network entity is described. The method may include transmitting a grant that allocates a set of resources for use by a UE and transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

An apparatus for wireless communications at a network entity is described. The apparatus may include a processor, memory coupled with the processor, and instructions stored in the memory. The instructions may be executable by the processor to cause the apparatus to transmit a grant that allocates a set of resources for use by a UE and transmit an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

Another apparatus for wireless communications at a network entity is described. The apparatus may include means for transmitting a grant that allocates a set of resources for use by a UE and means for transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

A non-transitory computer-readable medium storing code for wireless communications at a network entity is described. The code may include instructions executable by a processor to transmit a grant that allocates a set of resources for use by a UE and transmit an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

In some examples of the method, apparatuses, and non-transitory computer-readable medium described herein, transmitting the indication may include operations, features, means, or instructions for transmitting a message that explicitly indicates that the grant pertains to the communications between the UE and the energy-harvesting device, where the message may be an RRC message, a MAC-CE message, or DCI message.

In some examples of the method, apparatuses, and non-transitory computer-readable medium described herein, transmitting the indication may include operations, features, means, or instructions for transmitting a message indicative of a set of multiple resources dedicated for energy-harvesting communications, where the set of resources implicitly indicates that the grant pertains to the communications between the UE and the energy-harvesting device based on the set of resources being included in the set of multiple resources.

Some examples of the method, apparatuses, and non-transitory computer-readable medium described herein may further include operations, features, means, or instructions for transmitting a message indicating a time range, a frequency range, or a combination thereof for which the grant may be applicable, where the set of resources may be within the time range, the frequency range, or the combination thereof.

In some examples of the method, apparatuses, and non-transitory computer-readable medium described herein, the message may be an RRC message, a MAC-CE message, or DCI message.

In some examples of the method, apparatuses, and non-transitory computer-readable medium described herein, the set of resources pertaining to the communications between the UE and the energy-harvesting device includes a duration greater than 14 symbols.

Some examples of the method, apparatuses, and non-transitory computer-readable medium described herein may further include operations, features, means, or instructions for transmitting a second grant that allocates a second set of resources for the communications between the UE and the energy-harvesting device and transmitting a message indicating a time range, a frequency range, or a combination thereof for which the grant and the second grant may be applicable, where the set of resources and the second set of resources may be within the time range, the frequency range, or the combination thereof.

In some examples of the method, apparatuses, and non-transitory computer-readable medium described herein, the set of resources and the second set of resources may be adjacent in the time range.

In some examples of the method, apparatuses, and non-transitory computer-readable medium described herein, a set of frequency resources of the set of resources may be different from a second set of frequency resources of the second set of resources.

In some examples of the method, apparatuses, and non-transitory computer-readable medium described herein, the message may be an RRC message, a MAC-CE message, or DCI message.

Some examples of the method, apparatuses, and non-transitory computer-readable medium described herein may further include operations, features, means, or instructions for transmitting a message indicating whether the UE may be to transmit the energy-providing transmission to the energy-harvesting device to power on the energy-harvesting device.

In some examples of the method, apparatuses, and non-transitory computer-readable medium described herein, the set of resources includes one or more uplink-configured slots, one or more downlink-configured slots, or a combination thereof for the communications between the UE and the energy-harvesting device.

Some examples of the method, apparatuses, and non-transitory computer-readable medium described herein may further include operations, features, means, or instructions for transmitting the energy-providing transmission to power on the energy-harvesting device prior to the set of resources, where the network entity transmits the energy-providing transmission in a downlink configured slot, an uplink configured slot, or both.

Some examples of the method, apparatuses, and non-transitory computer-readable medium described herein may further include operations, features, means, or instructions for receiving a data signal from the energy-harvesting device, where the network entity receives the data signal in a downlink configured slot, an uplink configured slot, or both.

Some examples of the method, apparatuses, and non-transitory computer-readable medium described herein may further include operations, features, means, or instructions for transmitting a data signal to the energy-harvesting device, where the network entity transmits the data signal in a downlink configured slot, an uplink configured slot, or both.

In some examples of the method, apparatuses, and non-transitory computer-readable medium described herein, the grant may be an uplink grant or a downlink grant pertaining to the communications between the UE and the energy-harvesting device.

In some examples of the method, apparatuses, and non-transitory computer-readable medium described herein, the network entity configures the UE communicate with the energy-harvesting device in accordance with time division duplexing, frequency division duplexing, or a combination thereof.

### BRIEF DESCRIPTION OF THE DRAWINGS

FIG. 1 illustrates an example of a wireless communications system that supports techniques for performing passive internet of things (IoT) communications in accordance with one or more aspects of the present disclosure.

FIG. 2 illustrates an example of a wireless communications system that supports techniques for performing passive IoT communications in accordance with one or more aspects of the present disclosure.

FIG. 3 illustrates an example of a resource allocation scheme that supports techniques for performing passive IoT communications in accordance with one or more aspects of the present disclosure.

FIG. 4 illustrates an example of a resource allocation scheme that supports techniques for performing passive IoT communications in accordance with one or more aspects of the present disclosure.

FIG. 5 illustrates an example of a process flow that supports techniques for performing passive IoT communications in accordance with one or more aspects of the present disclosure.

FIGS. 6 and 7 show block diagrams of devices that support techniques for performing passive IoT communications in accordance with one or more aspects of the present disclosure.

FIG. 8 shows a block diagram of a communications manager that supports techniques for performing passive IoT communications in accordance with one or more aspects of the present disclosure.

FIG. 9 shows a diagram of a system including a device that supports techniques for performing passive IoT communications in accordance with one or more aspects of the present disclosure.

FIGS. 10 and 11 show block diagrams of devices that support techniques for performing passive IoT communications in accordance with one or more aspects of the present disclosure.

FIG. 12 shows a block diagram of a communications manager that supports techniques for performing passive IoT communications in accordance with one or more aspects of the present disclosure.

FIG. 13 shows a diagram of a system including a device that supports techniques for performing passive IoT communications in accordance with one or more aspects of the present disclosure.

FIGS. 14 through 17 show flowcharts illustrating methods that support techniques for performing passive IoT communications in accordance with one or more aspects of the present disclosure.

### DETAILED DESCRIPTION

Some wireless communications systems may support communications between a communication device (e.g., a network entity, user equipment (UE), an RFID reader, or some other energy transmitter device) and an energy-harvesting device. An energy-harvesting device may be a low power or passive communication device (e.g., a radio frequency identifier (RFID) tag, a passive Internet of Things (IoT) device, or some other energy-harvesting device) that uses energy harvested from signals to power one or more components of the energy-harvesting device and communicate with an energy transmitter device. An energy transmitter device may be a communication device that may transmit, to an energy-harvesting device, an energy-providing transmission (e.g., an energy signal) that may be harvested by the energy-harvesting device to support the communication of other signals between the energy transmitter device, the energy-harvesting device, and/or some other communication device. For example, an energy-harvesting device may perform passive IoT communications by transmitting or receiving an information signal (e.g., a backscattered information signal) to the energy transmitter using energy harvested from an energy-providing transmission.

In some cases, a UE may receive, from a network entity, one or more resource grants allocated for communications to be performed by the UE. However, the UE may not be able to differentiate resource grants dedicated for passive IoT communications and resource grants dedicated for other communications (e.g., New Radio (NR) communications). Additionally, in some communication systems, a network entity may not be capable of allocating grants for resources with a duration long enough to support passive IoT communications. For example, in some systems, a network entity may allocate grants not larger than 14 symbols (or 1 slot). However, a passive IoT communication procedure may last a duration larger than 14 symbols (e.g., 0.5 ms to tens of ms). Thus, a network entity may not be able to provide a continuous grant duration that supports a complete passive IoT communication procedure, thereby limiting the deployment of passive IoT communication procedures. Additionally, or alternatively, a UE or a network entity may not easily obtain continuous uplink or downlink slots in time domain duplexing (TDD) systems, impacting scheduling for passive IoT communications as passive IoT communications may be longer than a couple slots.

Techniques, systems, and devices are described herein to improve implementation of passive IoT communications in a wireless communications system by improving resource allocation methods for passive IoT communications. For example, a UE may receive, from a network entity, a resource grant that allocates a set of resources for use by the UE. Additionally, the UE may receive, from the network entity, an indication that the received grant pertains to communications between the UE and an energy-harvesting device, where the communications may include an energy-providing transmission to the energy-harvesting device, a data transmission to the energy-harvesting device, a data reception from the energy-harvesting device, or a combination thereof. In some examples, the UE may receive the indication via explicit signaling (e.g., radio resource control (RRC), medium access control (MAC) control element (MAC-CE), or downlink control information (DCI) signaling). Alternatively, the UE may receive the indication via implicit signaling. In an example of implicit signaling, the network entity may configure a resource pool dedicated for passive IoT communications. The network entity may then transmit the grant indicative of resources from the resource pool and the UE may therefore identify that the grant is for passive IoT communications. Accordingly, the UE may communicate with the energy-harvesting device in accordance with the grant.

In some aspects, the network entity may configure a grant for passive IoT communications indicative of resources that support a complete passive IoT communication procedure. For example, the UE may receive, from the network entity, a resource grant indicative of a set of resources for communications between the UE and an energy-harvesting device, where the set of resources lasts a duration greater than 14 symbols, in some cases. In some other aspects, the UE may receive, from the network entity, multiple resource grants to support the communications between the UE and the energy-harvesting device. Additionally, or alternatively, the UE may receive a message indicating a time range and/or a frequency range for which each individual resource grant is applicable and/or a time range and/or a frequency range for which the multiple resource grants are applicable. For example, the UE may receive a message indicating that the set of resources allocated by the multiple grants are within a time range, a frequency range, or both.

In some implementations, to support cohesive passive IoT communications, the network entity may configure one or more uplink resources, one or more downlink resources, or a combination thereof that may be used by the UE, the network entity, or both to support passive IoT communications (e.g., an energy-providing transmission to the energy-harvesting device, a data transmission to the energy-harvesting device, a data reception from the energy-harvesting device, or a combination thereof).

Accordingly, a network entity may allocate one or more uplink grants, and/or one or more downlink grants for a UE (or some other network device) to perform passive IoT communications. The network entity may indicate whether the one or more uplink and the one or more downlink grants are dedicated for passive IoT communications. In some cases, the uplink grants and/or the downlink grants may indicate resources longer than 14 symbols. In some cases, the network entity may indicate continuous wave (e.g., energy-providing transmission) information to the UE, such as a duration of the continuous wave prior to a data signal from or to the energy- harvesting device. Additionally, or alternatively, the network entity, the UE, or both may power up the energy-harvesting device (e.g., transmit energy-providing signals) in uplink slots, downlink slots, or both. Additionally, or alternatively, the network entity, the UE, or both may communicate data signals with the energy-harvesting device in uplink slots, downlink slots, or both.

Aspects of the subject matter described in this disclosure may be implemented to realize one or more of the following potential advantages, among others. The techniques employed by the described communication devices may allow for improved implementation of passive IoT communications in wireless communications systems such as NR systems. As a result, a UE may conduct passive IoT communications with high efficiency and reduced costs. For example, by receiving an indication that a received resource grant is dedicated for passive IoT communications, the UE may communicate with an energy-harvesting device more efficiently than if the UE were not to receive such an indication because the UE may not have been aware of the waveform and modulation/demodulation scheme to adopt in accordance with the received resource grant. As a result, the UE may be able to charge the energy-harvesting device more efficiently. Additionally, the network entity may configure the UE to transmit and/or receive signals in downlink configured slots, uplink configured slots, or both to perform IoT communication, resulting in reduced latency, increased throughput, and increased resource utilization efficiency.

Aspects of the disclosure are initially described in the context of wireless communications systems. Aspects are then described with reference to resource allocation schemes and a process flow. Aspects of the disclosure are further illustrated by and described with reference to apparatus diagrams, system diagrams, and flowcharts that relate to techniques for performing passive internet of things communications.

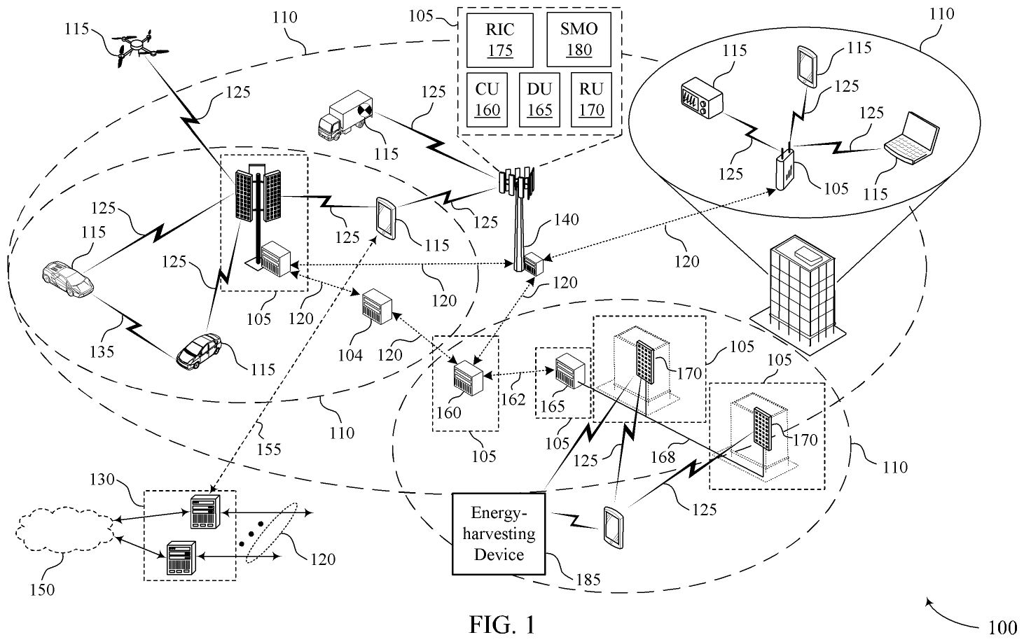

FIG. 1 illustrates an example of a wireless communications system 100 that supports techniques for performing passive IoT communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for performing passive internet of things communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single- user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The wireless communications system 100 may support passive IoT communications between an energy-harvesting device 185 and a UE 115, a network entity 105, or a combination thereof. Examples of the energy-harvesting device 185 include an RFID tag, a passive IoT device, and a UE 115 (e.g., a low power or low complexity UE 115), among other energy-harvesting devices. That is, the energy-harvesting device 185 may be a communication device that uses harvested energy (e.g., at least in part) from received energy-providing transmissions to perform wireless communications. For example, a UE 115 and/or a network entity 105 may transmit, to an energy-harvesting device 185, an energy-providing transmission that may be harvested by the energy-harvesting device 185 to support the communication of other signals (e.g., information signals) between the energy-harvesting device 185 and the UE 115 or between the energy-harvesting device 185 and the network entity 105, or a combination thereof. For example, the energy-harvesting device 185 may harvest and use energy from the energy-providing transmission (e.g., from a UE 115, and/or a network entity 105) to charge one or more components of the energy-harvesting device 185 and communicate with the UE 115 and/or the network entity 105 (e.g., process received information signals, transmit information signals, backscatter information signals).

In ultra-high frequency RFID systems, a UE 115, which may also be referred to as a reader or interrogator, may continuously occupy channels in an Industrial, Scientific, and Medical (ISM) band for a duration less than 0.4 s. In some examples, the UE 115 may enable a full duplex function, where the UE 115 operating in the full duplex function may transmit an unmodulated, single tone wave and simultaneously receive backscatter signals from an energy-harvesting device 185. When performing passive IoT communications, the UE 115 may transmit or receive a signal (e.g., an energy-providing transmission) in the format of a continuous wave between packets (e.g., query packets, acknowledgement packets). In some examples, the energy-harvesting device 185 may need to power up in order to be able to perform passive IoT communications with the UE 115. Accordingly, the UE 115 may power up the energy-harvesting device 185 by transmitting an energy-providing transmission in a continuous wave (e.g., lasting a duration of 400-800 μs) before the UE 115 or the energy-harvesting device 185 begins passive IoT communications. After receiving the energy-providing transmission in the continuous wave, the energy-harvesting device 185 may communicate with the UE 115.

In some cases, a passive IoT communications system, such as ultra-high frequency RFID systems, may be incompatible to the wireless communications system 100 because the passive IoT communications system and the wireless communications system 100 may operate on different frequency bands. For example, some systems may operate in a licensed band, and an ultra-high frequency RFID system may operate in a different band (e.g., an ISM band). Additionally, no interferences may be defined between the passive IoT communications system and the wireless communications system 100. Therefore, techniques for implementing passive IoT communications and other communications in a wireless communications system 100 may be improved.

In some examples, a UE 115 may receive one or more resource grants from a network entity 105, and the UE 115 may perform passive IoT communications and/or other wireless communications (e.g., NR communications) based on receiving the one or more resource grants. In some cases, the UE 115 may not be able to differentiate received resource grants dedicated for passive IoT communications and resource grants dedicated for other communications. Passive IoT communications may adopt a waveform and modulation/demodulation method that is different from what is used for other communications (e.g., NR communications). Because the UE 115 may not be able to differentiate resource grants dedicated to passive IoT communications versus other communications, the UE 115 may not be able to identify the type of waveform and modulation/demodulation method to be adopted.

Additionally, or alternatively, a network entity 105 may be unable to support resource allocation of a continuous duration grant for a passive IoT communication procedure. For example, a passive IoT communication procedure may last a duration of 0.5 ms to tens of ms. However, the network entity 105 may not be capable of allocating grants for resources with a duration time that is longer than 14 symbols, which may be significantly smaller than the duration for the passive IoT communication procedure. Accordingly, the network entity 105 may be unable to provide a continuous grant duration for the passive IoT communication procedure.

Additionally, or alternatively, a network entity 105 may allocate resource grants to a UE 115 in a FDD system or a TDD system for passive IoT communications between the UE 115 and an energy-harvesting device 185. In a TDD system, a UE 115 may communicate different signals on the same frequency band by utilizing separate time slots. For example, in a TDD system, a UE 115 may perform downlink and uplink communications on the same frequency channel by receiving downlink signals during a first slot (e.g., a downlink slot) and transmitting uplink signals during a second slot (e.g., an uplink slot) that is different from the first slot. In a FDD system, a UE 115 may communicate different signals during the same time slot by utilizing separate frequency bands. For example, a UE 115 in an FDD system may perform downlink and uplink communications during the same slot by receiving downlink signals on a first frequency channel (e.g., a downlink band) and transmitting uplink signals on a second frequency channel (e.g., an uplink band) that is different from the first channel. In some cases, a network entity 105 or a UE 115 may not easily obtain continuous uplink or downlink slots in a TDD system.

In accordance with the examples disclosed herein, the wireless communications system 100 may support passive IoT communications between an energy-harvesting device 185 and a UE 115 and/or a network entity 105 (e.g., or some other network device). For example, the UE 115 may receive, from a network entity 105, a grant that allocates a set of resources for use by the UE 115. Additionally, the UE 115 may receive an indication (e.g., implicitly, and/or explicitly) that the grant received at the UE 115 is dedicated to communications between the UE 115 and an energy- harvesting device 185. In some cases, the grant may be indicative of resources occupying more than 14 symbols. In some cases, the UE 115 may receive an indication of a time range, a frequency range, or both over which the passive IoT communications may occur. In some cases, the UE 115 may be configured to perform the passive IoT communications in uplink-configured slots, in downlink-configured slots, or a combination thereof. The communications may include an energy-providing transmission to the energy-harvesting device 185, a data transmission to the energy-harvesting device 185, a data reception from the energy-harvesting device 185, or a combination thereof. In accordance with the grant, the UE 115 may communicate with the energy-harvesting device 185 (e.g., using the set of resources included in the grant).

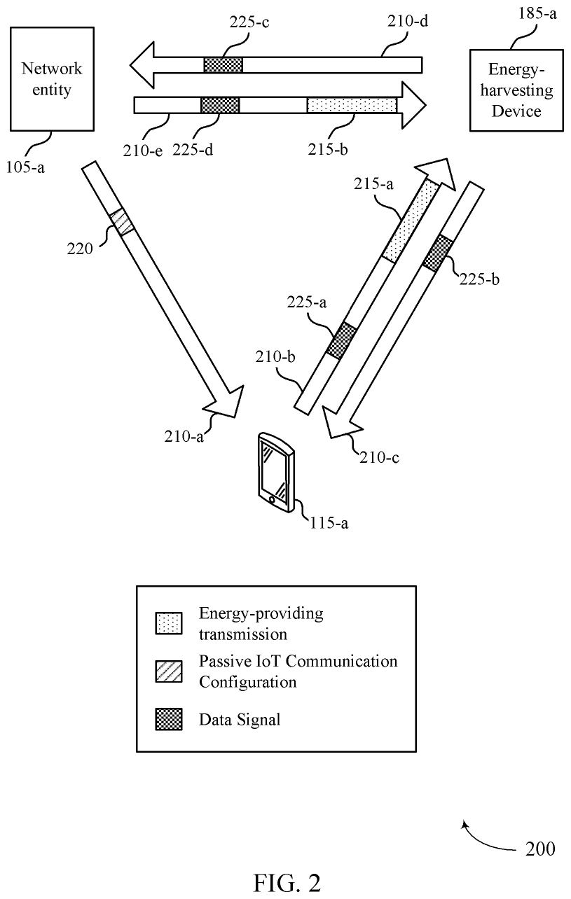

FIG. 2 illustrates an example of a wireless communications system 200 that supports techniques for performing passive IoT communications in accordance with one or more aspects of the present disclosure. The wireless communications system 200 may implement or be implemented by aspects of the wireless communications system 100 described with reference to FIG. 1. For example, the wireless communications system 200 may include a network entity 105-a, a UE 115-a, and an energy-harvesting device 185-a. In some examples, the network entity 105-a may be an example of a network entity 105 described with reference to FIG. 1, and the UE 115-a may be an example of a UE 115 described with reference to FIG. 1. In some examples, the energy-harvesting device 185-a may be an example of an energy-harvesting device 185 or a UE 115 described with reference to FIG. 1. The wireless communications system 200 may support wireless communications (e.g., communications between the network entity 105-a and the UE 115-a) which may support passive IoT communications between energy transfer devices (e.g., between the network entity 105-a and the energy-harvesting device 185-a, between the UE 115 and the energy-harvesting device 185-a, or a combination thereof), resulting in increased communication reliability, reduced latency, increased throughput and data rates, reduced power consumption, and improved (e.g., more efficient) power harvesting, among other benefits.

The wireless communications system 200 may support communications between the network entity 105-a, the UE 115-a, and the energy-harvesting device 185-a. The UE 115-a may communicate signals with the energy-harvesting device 185-a and the network entity 105-a over respective communication links 210, which may be examples of a communication link 125 described with reference to FIG. 1. For example, the network entity 105-a may communicate with the UE 115-a on a communication link 210-a, the UE 115-a and the energy-harvesting device 185-a may communicate using a communication link 210-b and a communication link 210-c, and the network entity 105 and the energy-harvesting device 185-a may communicate using a communication link 210-d and a communication link 210-e.

To support communications between the UE 115-a and the energy-harvesting device 185-a, the UE 115-a and/or the network entity 105-a may be configured to perform wireless power transfer to the energy-harvesting device 185-a. In some examples, the UE 115-a may transmit an energy-providing transmission 215-a (e.g., a continuous wave) to the energy-harvesting device 185-a over a communication link 210-b, and the energy-harvesting device 185-a may perform energy-harvesting operations to harvest energy from the energy-providing transmission 215-a for use in powering one or more components of the energy-harvesting device 185-a. In other examples, the network entity 105-a may transmit an energy-providing transmission 215-b to the energy-harvesting device 185-a over a communication link 210-e, and the energy-harvesting device 185-a may perform energy-harvesting operations to harvest energy from the energy-providing transmission 215-b for use in powering one or more components of the energy-harvesting device 185-a.

In some examples, the network entity 105-a may allocate one or more grants to the UE 115-a in a TDD system, an FDD system, or some other communications system (e.g., a combination of TDD and FDD systems). For example, the network entity 105-a may transmit a passive IoT communication configuration 220 to the UE 115-a indicative of one or more grants, and/or one or more parameters of the grants. In some aspects, the network entity 105-a may explicitly indicate resources to be used by the UE 115-a for passive IoT communication (e.g., explicitly indicate that a configured grant is for passive IoT communications). For instance, the network entity 105-a may transmit a grant that allocates a set of resources for use by the UE 115-a. Additionally, the network entity 105-a may transmit an indication (e.g., passive IoT communication configuration 220, or some other message) that the grant is to be used for passive IoT communications. In some cases, the network entity 105-a may explicitly indicate that the grant pertains to the communications (e.g., transmitting the energy-providing transmission 215-a, transmitting the data signal 225-a, receiving the data signal 225-b) between the UE 115-a and the energy-harvesting device 185-a. For instance, the network entity 105-a may transmit a message (e.g., passive IoT communication configuration 220) indicating that the grant pertains to the communications between the UE 115-a and the energy harvesting device 185-a via an RRC message, a MAC-CE message, a DCI message, or some other control message.

In other aspects, the network entity 105-a may implicitly indicate that a grant is for passive IoT communications. For instance, in some examples, the network entity 105-a may indicate a set of time resources, a set of frequency resources, or both dedicated for passive IoT communications by constructing and indicating resource pools to the UE 115-a in the passive IoT communication configuration 220, or some other message. In such examples, the network entity 105-a may transmit a grant (e.g., in the passive IoT communication configuration 220, or some other message) that allocates a set of resources for use by the UE 115-a. The UE 115-a may then determine whether the set of resources associated with the grant correspond to the set of time resources, the set of frequency resources, or both dedicated for passive IoT communications. If the resources included in the resource pools includes the set of resources indicated in the grant, the UE 115-a may identify that the grant pertains to passive IoT communications between the UE 115-a and the energy-harvesting device 185-a .

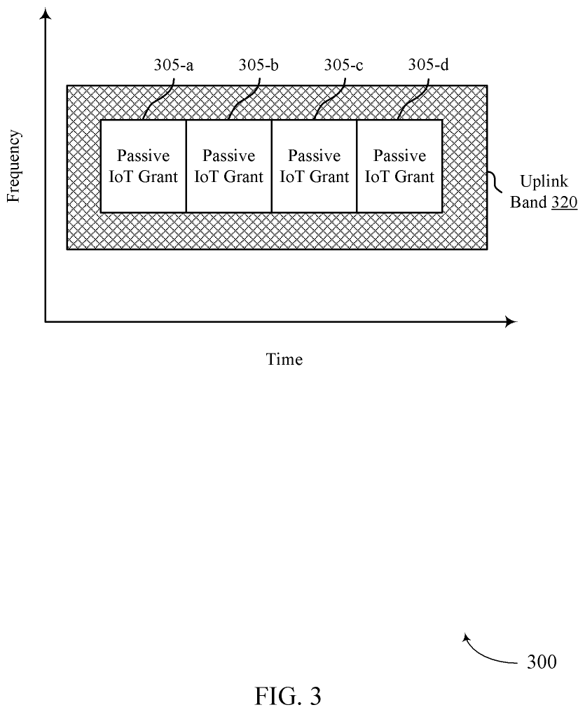

In some aspects, and as described in more detail with reference to FIG. 3, the passive IoT communication configuration 220 may indicate a time range, a frequency range, or both for which the grant or a set of passive IoT grants are applicable, where the time range, the frequency range, or both may be included in the set of resources indicated in the grant. The network entity 105-a may transmit the passive IoT communication configuration 220 in an RRC message, a MAC-CE message, a DCI message, or some other control message. In some cases, the network entity 105 may indicate one or more grants in a same message or a different message as the explicit indication that the one or more grants pertain to passive IoT communications, the implicit indication that the one or more grants pertain to passive IoT communications, the indication of the time range, the indication of the frequency range, etc.

In some aspects, and as described in more detail with reference to FIG. 3, the network entity 105-a may transmit a first grant and a second grant for communications between the UE 115-a and the energy-harvesting device 185-a. The first grant may allocate a first set of resources for use by the UE 115-a, while the second grant may allocate a second set of resources for communications between the UE 115-a and the energy-harvesting device 185-a. In such aspects, the network entity 105-a may transmit a message indicating a first time range and/or frequency range for which the first grant is applicable and a second time range and/or frequency range for which the second grant is applicable, and/or indicate a time range and/or frequency range for which the first grant and the second grant are applicable, where the first set of resources and the second set of resources are within the time range and/or the frequency range. The network entity 105-a may transmit the message via explicit signaling or implicit signaling. In some aspects, the first set of resources and the second set of resources may be adjacent in the time range, meaning that the resources are in continuous slots. Additionally, or alternatively, a set of frequency resources of the first set of resources may be different from a second set of frequency resources of the second set of resources, meaning that the frequency resources allocated by the first grant and the second grant may not be the same.

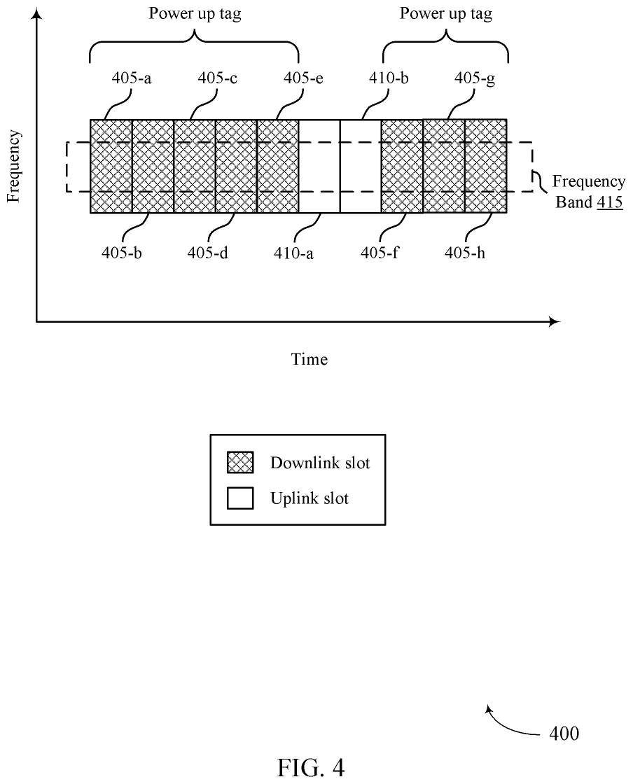

In some implementations, and as described in more detail with reference to FIG. 4, the UE 115-a may receive a grant allocating resources for use by the UE 115-a for passive IoT communications, where the grant may be an uplink grant, a downlink grant, or a combination thereof. That is, the network entity 105-a may indicate grants to the UE 115-a that span one or more uplink configured slots or symbols for passive IoT transmission as well as one or more downlink resources in downlink configured slots or symbols for passive IoT reception, passive IoT transmission, or both. For example, the UE 115-a may receive a grant allocating resources to the UE 115-a and receive an indication that the grant is dedicated to passive IoT communications. In accordance with the grant, the UE 115-a may transmit a data signal 225-a in a downlink configured slot, an uplink configured slot, or both based on the grant. Accordingly, the UE 115-a may be configured with continuous downlink and/or uplink configured resources allocated for passive IoT communications, such as passive IoT transmission (e.g., transmitting the energy-providing transmission 215-a, transmitting the data signal 225-a) or passive IoT reception (e.g., receiving the data signal 225-b).

In some examples, the UE 115-a may perform passive IoT communications in a monostatic scenario, which may also be referred to as a co-located bi-station scenario. In such examples, the UE 115-a may transmit an energy signal (e.g., an energy-providing transmission 215) and transmit and/or receive a backscattered signal (e.g., a data signal 225, a data signal 225-b) with the energy-harvesting device 185. That is, the UE 115-a may serve as an RF source and perform backscatter reception in the monostatic scenario. In other examples, the UE 115-a or the network entity 105-a may perform passive IoT communications in a bistatic scenario. In some such examples, the UE 115-a may transmit the energy-providing transmission 215-a to the energy-harvesting device 185-a, and the network entity 105-a may transmit and/or receive a backscattered signal (e.g., the data signal 225-a, the data signal 225-b) with the energy-harvesting device 185. In other such examples, the network entity 105-a may transmit an energy-providing transmission 215-b to the energy-harvesting device 185-a, and the UE 115-a may transmit and/or receive the backscattered signal (e.g., a data signal 225-c, a data signal 225-d) with the energy-harvesting device 185.

By implementing resource allocation methods for implementation of passive IoT communications in the wireless communications system 200, communication characteristics of signals communicated between the network entity 105-a, the UE 115-a, and the energy-harvesting device 185-a may be improved. For example, by receiving an indication that resources received in a grant are dedicated to passive IoT communication (e.g., implicitly, or explicitly), the UE 115-a may determine to adopt a waveform and modulation/demodulation scheme to perform passive IoT communication efficiently, enabling power savings and reduced latency, among other benefits. Additionally, a reliability, a throughput, and a data rate of the signals may be increased, among other benefits.

FIG. 3 illustrates an example of a resource allocation scheme 300 that supports techniques for performing passive IoT communications in accordance with one or more aspects of the present disclosure. The resource allocation scheme 300 may implement or be implemented by aspects of the wireless communications system 100 or 200 described with reference to FIGS. 1 and 2, respectively. For example, the resource allocation scheme 300 may be implemented by the UE 115-a or the network entity 105-a described with reference to FIG. 2, which may be examples of the corresponding devices described with reference to FIG. 1.

As discussed with reference to FIG. 2, the UE 115-a may perform passive IoT communications with an energy-harvesting device 185-a in a FDD system, a TDD system, or some other system by allocating one or more grants in a set of continuous slots. In some examples, a UE 115 may communicate with an energy-harvesting device 185 over a frequency range, such as a frequency range on an uplink band 320. The UE 115 may receive one or multiple grants for passive IoT communications. For example, the UE 115 may receive a passive IoT grant 305-a, a passive IoT grant 305-b, a passive IoT grant 305-c, and a passive IoT grant 305-d. Each of the passive IoT grants 305 may be dedicated to passive IoT communications with one or more energy-harvesting devices. In some examples, the frequencies of the grants may be the same. Alternatively, the frequencies of the grants may be different. For instance, the UE 115 may receive passive IoT grants 305, where each of the passive IoT grants 305 allocates a set of resources for use by the UE 115 to perform passive IoT communications.

In some aspects, the UE 115 may receive an indication (e.g., explicitly, or implicitly) that one or more of the passive IoT grants 305 are dedicated to the UE 115 for passive IoT communications. Accordingly, the UE 115 may use the one or more passive IoT grants 305 to perform a passive IoT communication procedure (e.g., transmit an energy-providing transmission to the energy-harvesting device 185, transmit and/or receive a data signal from the energy harvesting device 185). In some cases, the passive IoT grants 305 may be adjacent to one another so as to support continuous passive IoT communications.

In some cases, the passive IoT communication procedure may last a duration that is greater than 14 symbols (e.g., greater than a slot). For instance, the passive IoT communication procedure may last a duration of 0.5 ms to tens of ms, which may be a duration greater than 14 symbols. In some aspects, the UE 115 may receive an indication including an explicit or implicit message that indicates a time range, a frequency range, or both for which the one or more of the passive IoT grants 305 may be applicable in order to support the passive IoT communication procedure. In such aspects, the resources included in the one or more passive IoT grants 305 may be within the indicated time range, the frequency range, or both. For example, the UE 115 may receive the passive IoT grants 305 for use by the UE 115. The UE 115 may also receive an indication of a time-frequency range of each allocated grant and/or a time range for all allocated grants combined that are dedicated to a passive IoT communication. The set of resources included in each passive IoT grant 305 may be a duration larger than 14 symbols and/or the set of resources associated with all configured grants (e.g., passive IoT grants 305) may be duration larger than 14 symbols.

In some cases, the UE 115 may receive the time range, the frequency range, or both in an RRC message, a MAC-CE message, and/or a DCI message. In some cases, the UE 115 may receive the time range, a frequency range, or both in the same message or a different message than the message that indicates the one or more grants. Accordingly, the UE 115 may communicate with the energy-harvesting device 185 by using the passive IoT grants 305 to perform the passive IoT communication procedure.

FIG. 4 illustrates an example of a resource allocations scheme 400 that supports techniques for performing passive IoT communications in accordance with one or more aspects of the present disclosure. The resource allocation scheme 400 may implement or be implemented by aspects of the wireless communications system 100 described with reference to FIG. 1 and/or wireless communications system 200 described with reference to FIG. 2. For example, the resource allocation scheme 400 may be implemented by the UE 115-a, the network entity 105-a, or the energy-harvesting device 185-a described with reference to FIG. 2, which may be examples of the corresponding devices described with reference to FIG. 1. In some cases, the techniques described with reference to resource allocation scheme 400 may be combined with the techniques described with reference to resource allocation scheme 300.

In some examples, the UE 115 may perform passive IoT communications in an FDD scheme. Alternatively, the UE 115 may perform passive IoT communications in a TDD scheme. In a TDD system that includes the resource allocation scheme 400, the network entity 105 may configure one or more downlink slots 405 (e.g., downlink symbols) and one or more uplink slots 410 (e.g., uplink symbols) for communications performed by the UE 115. For example, the network entity 105 may configure a downlink slot 405-a, a downlink slot 405-b, a downlink slot 405-c, a downlink slot 405-c, a downlink slot 405-d, a downlink slot 405-e, a downlink slot 405-f, a downlink slot 405-g, and a downlink slot 405-h. Additionally, the network entity 105 may configure an uplink slot 410-a and an uplink slot 405-b. In some examples, the network entity 105 may configure the downlink slots 405 and the uplink slots 410 such that the downlink slots 405 and the uplink slots 410 are continuous in the time domain. In other examples, the downlink slots 405 and the uplink slots 410 may be discontinuous in the time domain. In some aspects, the downlink slots 405 and the uplink slots 410 may occupy the same frequency domain, such as a frequency band 415. In other aspects, the downlink slots 405 and the uplink slots 410 may occupy different frequencies.

In some examples, the UE 115 may receive a grant that allocates a set of resources to be used by the UE 115, and the UE 115 may also receive an indication that the grant pertains to passive IoT communications. The set of resources allocated by the grant may include one or more downlink-configured slots (e.g., one or more of the downlink slots 405), one or more uplink-configured slots (e.g., one or more of the uplink slots 410), or a combination of the one or more downlink-configured slots and the one or more uplink-configured slots for the communications between the UE 115 and the energy-harvesting device 185.

In some aspects, the network entity 105, or some other network device may send (e.g., transmit) an energy-providing transmission to the energy-harvesting device 185. In other aspects, the UE 115 may send the energy-providing transmission to the energy-harvesting device 185. The network entity 105 or the UE 115 may power up (e.g., power on) an energy-harvesting device 185 that is currently off or low on battery life by transmitting a duration of an unmodulated wave, such as an energy-providing transmission, so that the energy-harvesting device 185 is on to communicate data signals with the UE 115 and/or network entity 105. In some examples, the UE 115 may receive a grant allocating a set of resources, and the network entity 105 or the UE 115 may power up the energy-harvesting device 185 in accordance with the grant. For example, the UE 115 may receive a grant allocating one or more downlink slots 405 and/or one or more uplink slots 410 for passive IoT communication, and the UE 115 may also receive an indication that the grant pertains to passive IoT communications. The UE 115 may receive a message indicating whether the UE 115 is to transmit an energy signal (e.g., an energy-providing transmission) to the energy-harvesting device 185 to power on the energy harvesting device 185. If the UE 115 receives a message indicating that the UE 115 is to transmit an energy-providing transmission to the energy-harvesting device 185 to power on the energy-harvesting device 185, the UE 115 may transmit the energy-providing transmission using one or more of the downlink slots 405 allocated in one or more passive IoT grants. Additionally, or alternatively, the UE 115 may transmit the energy-providing transmission using one or more of the uplink slots 410. If the UE 115 does not receive a message indicating that the UE 115 is to transmit an energy-providing transmission to the energy-harvesting device 185, then the network entity 105 or another energy transmitting device in the wireless communications system may transmit an energy-providing transmission to the energy-harvesting device 185 to power on the energy-harvesting device 185 during the downlink slots 405, the uplink slots 410, or both. In some cases, the network entity 105 may transmit an indication to the UE 115 that the network entity 105 or another energy transmitting device in the wireless communications system may transmit an energy-providing transmission to the energy-harvesting device 185 to power on the energy-harvesting device 185 during the downlink slots 405, the uplink slots 410, or both but prior to the data communications between the energy-harvesting device 185, the UE 115, and/or the network entity 105.

In some aspects, the UE 115 may transmit a data signal to the energy-harvesting device 185 in one or more downlink configured slots, one or more uplink configured slots, or a combination thereof in accordance with one or more passive IoT grants. Additionally, or alternatively, the UE 115 may receive a data signal in one or more downlink configured slots, one or more uplink configured slots, or a combination thereof in accordance with one or more passive IoT grants. In some examples, the UE 115 may perform passive IoT communications by transmitting an energy-providing transmission to the energy-harvesting device 185 in one or more resources of the set of resources which are adjacent to data signals transmitted to or received from the energy-harvesting device 185. For example, the UE 115 may indicate one or more grants in the uplink slots 410 and the downlink slots 405, where the uplink slots 410 and the downlink slots 405 are adjacent to one another. In accordance with the grants, the UE 115 may transmit the energy-providing transmission to the energy-harvesting device 185 in a subset of slots including the uplink slots 410, the downlink slots 405, or both, where the subset of slots used to transmit the energy-providing transmission are adjacent to the data signal that the energy-harvesting device 185 may transmit or receive, as described with reference to FIG. 2. For instance, the UE 115 may transmit the energy-providing transmission in one or more of the downlink slots 405 (e.g., the downlink slot 405-d and the downlink slot 405-e), and the UE 115 may transmit or receive one or more data signals (e.g., backscatter signals) in one or more adjacent slots (e.g., the downlink slot 405-b and the downlink slot 405-c or the uplink slot 410-a and the uplink slot 410-b).

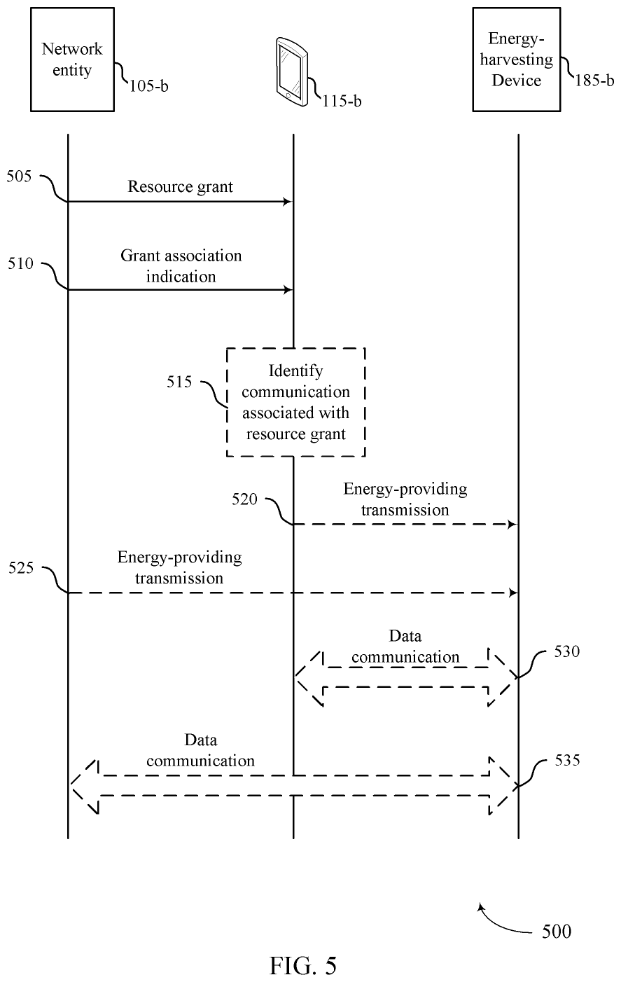

FIG. 5 illustrates an example of a process flow 500 that supports techniques for performing passive IoT communications in accordance with one or more aspects of the present disclosure. The process flow 500 may be implemented by aspects of the wireless communications systems 100 as described with reference to FIG. 1 and/or wireless communications system 200 as described with reference to FIG. 2. For example, a UE 115-b may be an example of a UE 115 as described with reference to FIG. 1 and a UE 115-a as described with reference to FIG. 2, and a network entity 105-b may be an example of a network entity 105 as described with reference to FIG. 1 and a network entity 105-a as described with reference to FIG. 2. Similarly, an energy-harvesting device 185-b may be an example of an energy-harvesting device 185 as described with reference to FIG. 1 and an energy-harvesting device 185-a as described with reference to FIG. 2. Alternative examples of the following may be implemented, where some steps are performed in a different order than described or are not performed at all. In some cases, steps may include additional features not mentioned below, or further steps may be added.

At 505, the network entity 105-b may transmit, and the UE 115-b may receive, a grant that allocates a set of resources (e.g., time resources, frequency resources) for use by the UE 115-b. In some aspects, the grant may be an uplink grant. Alternatively, the grant may be a downlink grant. The grant may contain resources that are dedicated to communications to be performed by the UE 115-b, such as passive IoT communications or other communications (e.g., NR communications). In some examples, the set of resources pertaining to passive IoT communication between the UE 115-b and the energy-harvesting device may last a duration greater than 14 symbols. In some examples, the network entity 105-b may transmit, and the UE 115-b may receive, a second grant that allocates a second set of resources for the communications between the UE 115-b and the energy-harvesting device 185-b. In some examples, a set of frequency resources of the set of resources may be different from a second set of frequency resources of the second set of resources. Additionally, or alternatively, the set of resources and the second set of resources may be adjacent in a time range. In some aspects, the set of resources, the second set of resources, or both may include one or more uplink-configured slots, one or more downlink-configured slots, or a combination of the one or more uplink-configured slots and the one or more downlink configured slots for communications between the UE 115-b and the energy-harvesting device 185-a.

At 510, the network entity 105-b may transmit, and the UE 115-b may receive, a grant association indication indicating that the grant received at 505 pertains to communications between the UE 115-b and the energy-harvesting device 185-b. The communications between the UE 115-b and the energy-harvesting device 185-b may include at least one of an energy-providing transmission to the energy-harvesting device 185-b, a data transmission to the energy-harvesting device 185-b, or a data reception from the energy-harvesting device 185-b. In some examples, the network entity 105-b may transmit the grant association indication explicitly or implicitly. For example, the network entity 105-b may transmit, and the UE 115-b may receive, a message that explicitly indicates that the grant received at 505 pertains to the communications between the UE 115-b and the energy-harvesting device 185-b, where the message may be an RRC message, a MAC-CE message, or a DCI message. In other examples, the network entity 105-b may transmit, and the UE 115-b may receive, a message indicative of a plurality of resources dedicated for energy-harvesting communications. That is, the network entity 105-b may implicitly transmit the grant association indication by constructing and indicating resource pools to the UE 115-b. In some aspects, the UE 115-b may receive a message indicating a time range, a frequency range, or both for which the grant is applicable. In such aspects, the set of resources allocated by the grant may be within the time range, the frequency range, or both. In other aspects, the UE 115-b may receive a message indicating a time range, a frequency range, or both for which a grant and a second grant are applicable. In such other aspects, the set of resources allocated by the grant and the second set of resources allocated by the second grant may be within the time range, the frequency range, or a combination thereof. In some examples, the message may be an RRC message, a MAC-CE message, or a DCI message.

At 515, the UE 115-b may identify the communication associated with the resource grant received at 505. For example, if at 510, the UE 115-b receives a message indicative of a plurality of resources dedicated for energy-harvesting communications, the UE 115-b may identify that the grant pertains to the communications between the UE 115-b and the energy-harvesting device 185-b based on the plurality of resources including the set of resources. Accordingly, the UE 115-b may know to take a passive IoT communication strategy for transmission or reception.

At 520, the UE 115-b may transmit, and the energy-harvesting device 185-b may receive, an energy-providing transmission. In some examples, the UE 115-b may receive a message indicating whether the UE 115-b is to transmit the energy-providing transmission to the energy-harvesting device to power on the energy-harvesting device 185-b, and the UE 115-b may transmit the energy-providing transmission based on receiving that message. The UE 115-b may transmit the energy-providing transmission to the energy-harvesting device 185-b to power on the energy-harvesting device 185-b. In some examples, the UE 115-b may transmit the energy-providing transmission to the energy-harvesting device 185-b in accordance with the grant received at 505, where the UE 115-b may transmit the energy-providing transmission in a downlink configured slot, an uplink configured slot, or both. Additionally, or alternatively, the UE 115-b may transmit the energy-providing transmission to the energy-harvesting device 185-b in one or more resources of the set of resources adjacent to a data signal transmitted to or received from the energy-harvesting device 185-b.

At 525, the network entity 105-b may transmit, and the energy-harvesting device 185-b may receive, an energy-providing transmission. The network entity 105-b may transmit the energy-providing transmission using the same or similar techniques to those which the UE 115-b may use to transmit the energy-providing transmission. In some cases, both the network entity 105-b and the UE 115-b may transmit the energy-providing transmission to the energy-harvesting device 185-b at the same time, or at different times. Alternatively, one of the network entity 105-b or the UE 115-b may transmit the energy-providing transmission.

At 530, the UE 115-b may communicate data signaling with the energy-harvesting device 185-b in accordance with the grant received at 505. In some examples, the UE 115-b may communicate with the energy-harvesting device 185-b by receiving, from the energy-harvesting device 185-b, a data signal in accordance with the grant. The UE 115-b may receive the data signal in a downlink configure slot, an uplink configured slot, or both. In other examples, the UE 115-b may communicate with the energy-harvesting device 185-b by transmitting, to the energy-harvesting device 185-b, a data signal in a downlink configured slot, an uplink configured slot, or both.

At 535, the network entity 105-b may communicate data signaling with the energy-harvesting device 185-b. In some examples, the network entity 105-b may communicate with the energy-harvesting device 185-b by receiving, from the energy-harvesting device 185-b, a data signal. In other examples, the network entity 105-b may communicate with the energy-harvesting device 185-b by transmitting, to the energy-harvesting device 185-b, a data signal. In some cases, both the network entity 105-b and the UE 115-b may perform data communications with the energy-harvesting device 185-b at the same time, or at different times. Alternatively, one of the network entity 105-b or the UE 115-b may perform data communications with the energy-providing transmission.

In some cases, the energy-harvesting device 185-b may transmit a data signal to UE 115-b and the UE 115-b may relay the data signal to the network entity 105-b. Similarly, the energy-harvesting device 185-b may transmit a data signal to the network entity 105-b and the network entity 105-b may relay the data signal to UE 115-b. In some cases, the UE 115-a may receive a data signal from the network entity 105-b and may relay the data signal to the energy-harvesting device 185-b. Similarly, the UE 115-a may transmit a data signal to the network entity 105-b and the network entity 105-b may relay the data signal to the energy-harvesting device 185-b.

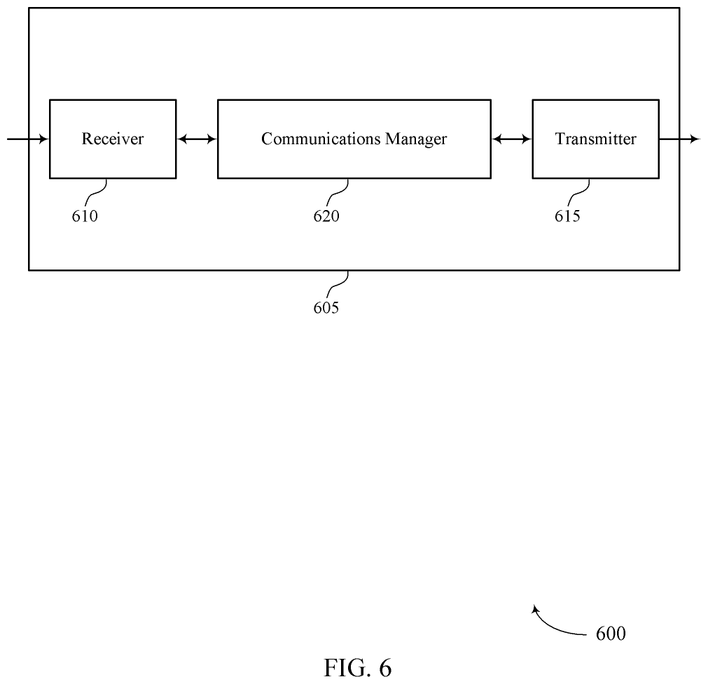

FIG. 6 shows a block diagram 600 of a device 605 that supports techniques for performing passive internet of things communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for performing passive internet of things communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for performing passive internet of things communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for performing passive internet of things communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, from a network entity, a grant that allocates a set of resources for use by the UE. The communications manager 620 may be configured as or otherwise support a means for receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device. The communications manager 620 may be configured as or otherwise support a means for communicating with the energy-harvesting device in accordance with the grant.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources, for example, by receiving an indication allowing the device 605 to be aware of a wave form and modulation/demodulation scheme to adopt for communications with an energy-harvesting device in accordance with a received resource grant, supporting increased communication reliability, increased throughput and data rates, and reduced latency, among other benefits.

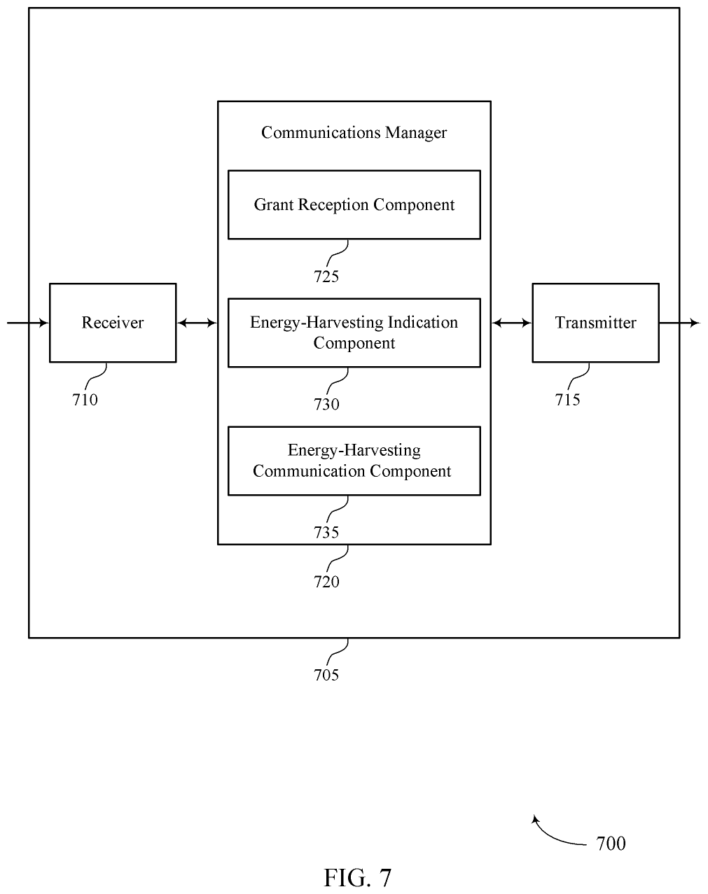

FIG. 7 shows a block diagram 700 of a device 705 that supports techniques for performing passive internet of things communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for performing passive internet of things communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for performing passive internet of things communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for performing passive internet of things communications as described herein. For example, the communications manager 720 may include a grant reception component 725, an energy-harvesting indication component 730, an energy-harvesting communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The grant reception component 725 may be configured as or otherwise support a means for receiving, from a network entity, a grant that allocates a set of resources for use by the UE. The energy-harvesting indication component 730 may be configured as or otherwise support a means for receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device. The energy-harvesting communication component 735 may be configured as or otherwise support a means for communicating with the energy-harvesting device in accordance with the grant.

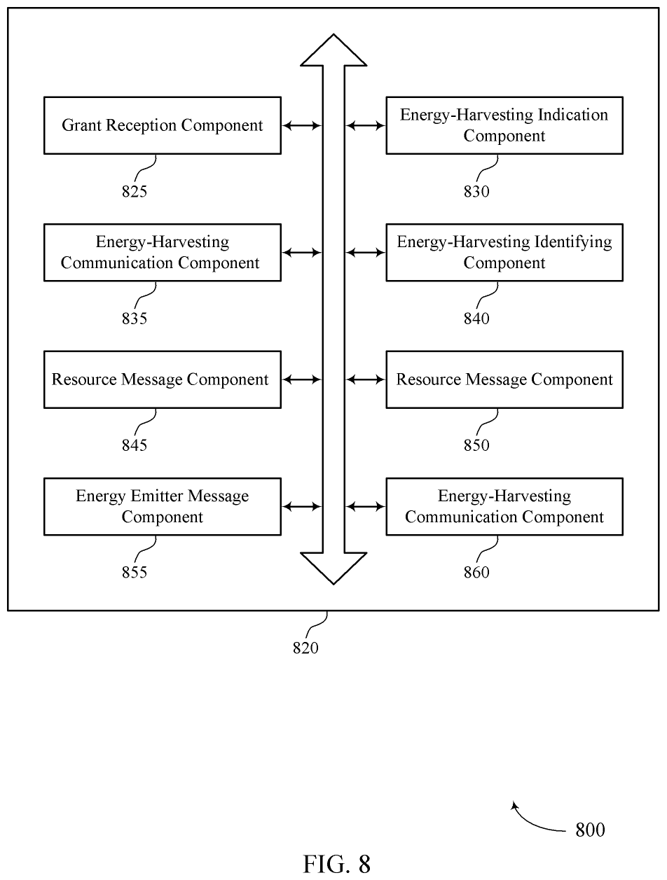

FIG. 8 shows a block diagram 800 of a communications manager 820 that supports techniques for performing passive internet of things communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for performing passive internet of things communications as described herein. For example, the communications manager 820 may include a grant reception component 825, an energy-harvesting indication component 830, an energy-harvesting communication component 835, an energy-harvesting identifying component 840, a resource message component 845, a resource message component 850, an energy emitter message component 855, an energy-harvesting communication component 860, or any combination thereof. Each of these components may communicate, directly or indirectly, with one another (e.g., via one or more buses).

The communications manager 820 may support wireless communications at a UE in accordance with examples as disclosed herein. The grant reception component 825 may be configured as or otherwise support a means for receiving, from a network entity, a grant that allocates a set of resources for use by the UE. The energy-harvesting indication component 830 may be configured as or otherwise support a means for receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device. The energy-harvesting communication component 835 may be configured as or otherwise support a means for communicating with the energy-harvesting device in accordance with the grant.

In some examples, to support receiving the indication, the energy-harvesting indication component 830 may be configured as or otherwise support a means for receiving a message that explicitly indicates that the grant pertains to the communications between the UE and the energy-harvesting device, where the message is a RRC message, a MAC-CE message, or DCI message.

In some examples, to support receiving the indication, the energy-harvesting indication component 830 may be configured as or otherwise support a means for receiving a message indicative of a set of multiple resources dedicated for energy-harvesting communications. In some examples, to support receiving the indication, the energy-harvesting identifying component 840 may be configured as or otherwise support a means for identifying that the grant pertains to the communications between the UE and the energy-harvesting device based on the set of multiple resources including the set of resources.

In some examples, the resource message component 845 may be configured as or otherwise support a means for receiving a message indicating a time range, a frequency range, or a combination thereof for which the grant is applicable, where the set of resources are within the time range, the frequency range, or the combination thereof.

In some examples, the message is a RRC message, a MAC-CE message, or DCI message.

In some examples, the set of resources pertaining to the communications between the UE and the energy-harvesting device includes a duration greater than 14 symbols.

In some examples, the grant reception component 825 may be configured as or otherwise support a means for receiving, from the network entity, a second grant that allocates a second set of resources for the communications between the UE and the energy-harvesting device. In some examples, the resource message component 850 may be configured as or otherwise support a means for receiving a message indicating a time range, a frequency range, or a combination thereof for which the grant and the second grant are applicable, where the set of resources and the second set of resources are within the time range, the frequency range, or the combination thereof.

In some examples, the set of resources and the second set of resources are adjacent in the time range.

In some examples, a set of frequency resources of the set of resources is different from a second set of frequency resources of the second set of resources.

In some examples, the message is a RRC message, a MAC-CE message, or DCI message.

In some examples, the energy emitter message component 855 may be configured as or otherwise support a means for receiving a message indicating whether the UE is to transmit the energy-providing transmission to the energy-harvesting device to power on the energy-harvesting device.

In some examples, the set of resources include one or more uplink-configured slots, one or more downlink-configured slots, or a combination thereof for the communications between the UE and the energy-harvesting device.

In some examples, to support communicating with the energy-harvesting device, the energy-harvesting communication component 860 may be configured as or otherwise support a means for transmitting, to the energy-harvesting device, the energy-providing transmission to power on the energy-harvesting device in accordance with the grant, where the UE transmits the energy-providing transmission in a downlink configured slot, or an uplink configured slot, or both.

In some examples, the UE transmits the energy-providing transmission to the energy-harvesting device in one or more resources of the set of resources adjacent to a data signal transmitted to or received from the energy-harvesting device.

In some examples, to support communicating with the energy-harvesting device, the energy-harvesting communication component 860 may be configured as or otherwise support a means for receiving, from the energy-harvesting device, a data signal in accordance with the grant, where the UE receives the data signal in a downlink configured slot, an uplink configured slot, or both.

In some examples, to support communicating with the energy-harvesting device, the energy-harvesting communication component 860 may be configured as or otherwise support a means for transmitting, to the energy-harvesting device, a data signal in accordance with the grant, where the UE transmits the data signal in a downlink configured slot, an uplink configured slot, or both.

In some examples, the grant is an uplink grant or a downlink grant pertaining to the communications between the UE and the energy-harvesting device.

In some examples, the UE communicates with the energy-harvesting device in accordance with time division duplexing, frequency division duplexing, or a combination thereof.

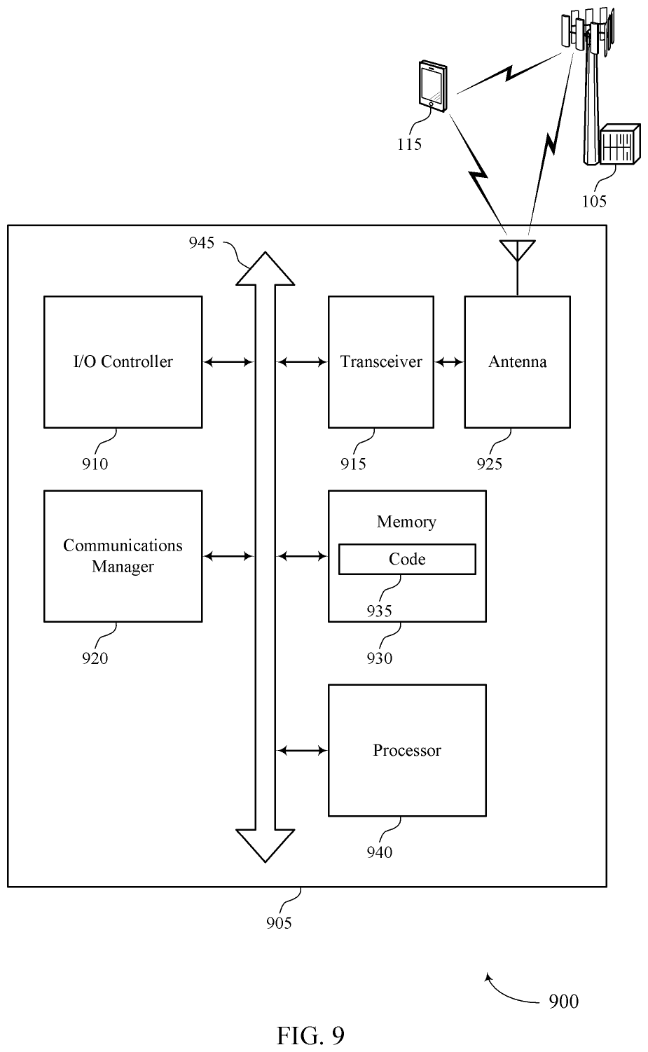

FIG. 9 shows a diagram of a system 900 including a device 905 that supports techniques for performing passive internet of things communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for performing passive internet of things communications). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a network entity, a grant that allocates a set of resources for use by the UE. The communications manager 920 may be configured as or otherwise support a means for receiving an indication that the grant received at the UE pertains to communications between the UE and an energy-harvesting device, where the communications include at least one of an energy-providing transmission to the energy- harvesting device, a data transmission to the energy-harvesting device, or a data reception from the energy-harvesting device. The communications manager 920 may be configured as or otherwise support a means for communicating with the energy-harvesting device in accordance with the grant.

By including or configuring the communications manager 920 in accordance with examples as described herein, the device 905 may support techniques for improved resource allocation for passive IoT communication in a wireless communications system, contributing to increased communication reliability, reduced latency, increased throughput, reduced power consumption, improved (e.g., more efficient) power harvesting, more efficient utilization of communication resources, improved coordination between devices, and longer battery life, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for performing passive internet of things communications as described herein, or the processor 940 and the memory 930 may be otherwise configured to perform or support such operations.

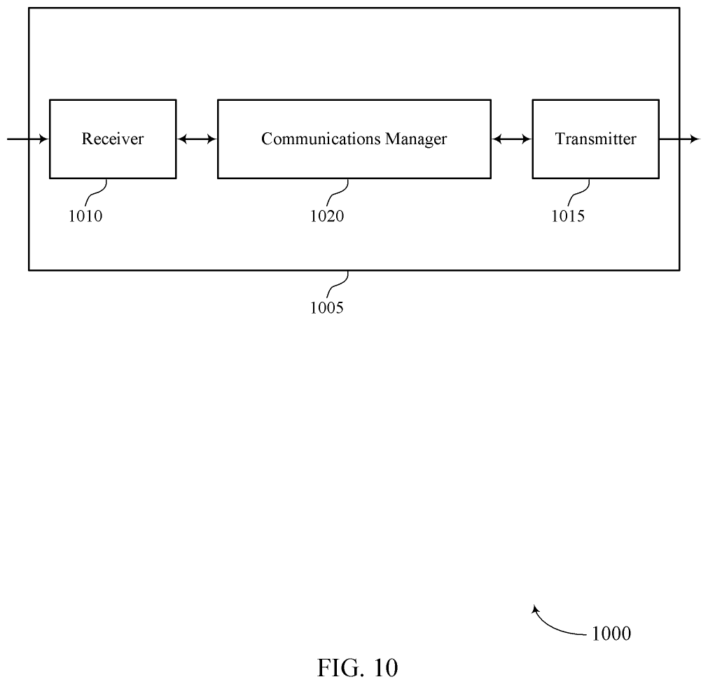

FIG. 10 shows a block diagram 1000 of a device 1005 that supports techniques for performing passive internet of things communications in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for performing passive internet of things communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting a grant that allocates a set of resources for use by a UE. The communications manager 1020 may be configured as or otherwise support a means for transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources, for example, by receiving an indication allowing the device 1005 to be aware of a wave form and modulation/demodulation scheme to adopt for communications with an energy-harvesting device in accordance with a received resource grant, supporting increased communication reliability, increased throughput and data rates, and reduced latency, among other benefits.

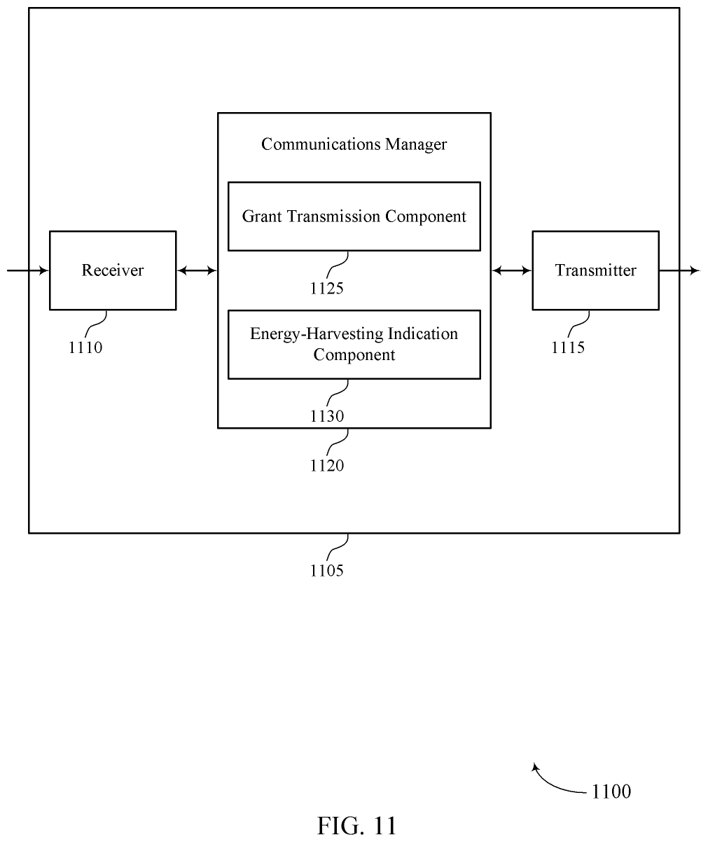

FIG. 11 shows a block diagram 1100 of a device 1105 that supports techniques for performing passive internet of things communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for performing passive internet of things communications as described herein. For example, the communications manager 1120 may include a grant transmission component 1125 an energy-harvesting indication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The grant transmission component 1125 may be configured as or otherwise support a means for transmitting a grant that allocates a set of resources for use by a UE. The energy-harvesting indication component 1130 may be configured as or otherwise support a means for transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

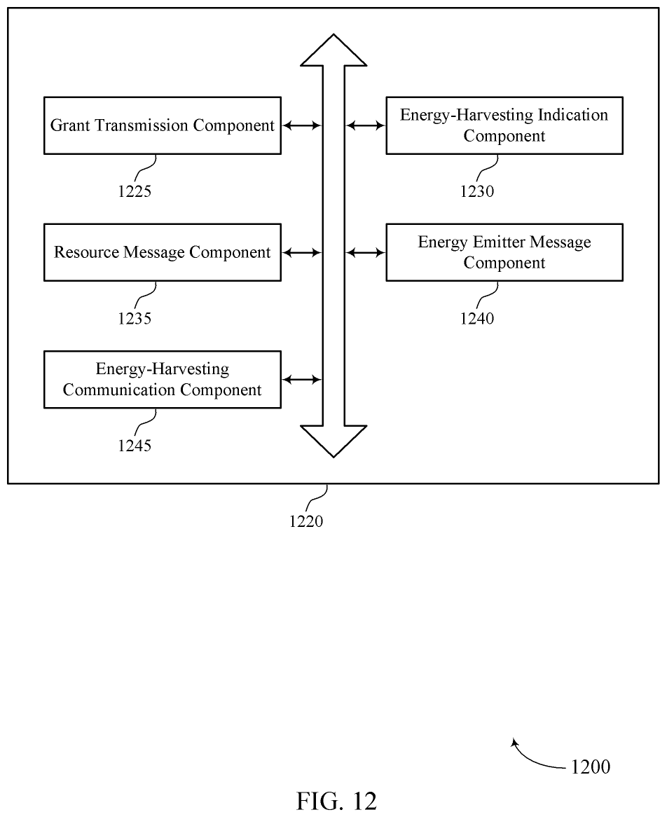

FIG. 12 shows a block diagram 1200 of a communications manager 1220 that supports techniques for performing passive internet of things communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for performing passive internet of things communications as described herein. For example, the communications manager 1220 may include a grant transmission component 1225, an energy-harvesting indication component 1230, a resource message component 1235, an energy emitter message component 1240, an energy-harvesting communication component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The grant transmission component 1225 may be configured as or otherwise support a means for transmitting a grant that allocates a set of resources for use by a UE. The energy-harvesting indication component 1230 may be configured as or otherwise support a means for transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device.

In some examples, to support transmitting the indication, the energy-harvesting indication component 1230 may be configured as or otherwise support a means for transmitting a message that explicitly indicates that the grant pertains to the communications between the UE and the energy-harvesting device, where the message is a RRC message, a MAC-CE message, or DCI message.

In some examples, to support transmitting the indication, the energy-harvesting indication component 1230 may be configured as or otherwise support a means for transmitting a message indicative of a set of multiple resources dedicated for energy-harvesting communications, where the set of resources implicitly indicates that the grant pertains to the communications between the UE and the energy-harvesting device based on the set of resources being included in the set of multiple resources.

In some examples, the resource message component 1235 may be configured as or otherwise support a means for transmitting a message indicating a time range, a frequency range, or a combination thereof for which the grant is applicable, where the set of resources are within the time range, the frequency range, or the combination thereof.

In some examples, the message is a RRC message, a MAC-CE message, or DCI message.

In some examples, the set of resources pertaining to the communications between the UE and the energy-harvesting device includes a duration greater than 14 symbols.

In some examples, the grant transmission component 1225 may be configured as or otherwise support a means for transmitting a second grant that allocates a second set of resources for the communications between the UE and the energy-harvesting device. In some examples, the resource message component 1235 may be configured as or otherwise support a means for transmitting a message indicating a time range, a frequency range, or a combination thereof for which the grant and the second grant are applicable, where the set of resources and the second set of resources are within the time range, the frequency range, or the combination thereof.

In some examples, the set of resources and the second set of resources are adjacent in the time range.

In some examples, a set of frequency resources of the set of resources is different from a second set of frequency resources of the second set of resources.

In some examples, the message is a RRC message, a MAC-CE message, or DCI message.

In some examples, the energy emitter message component 1240 may be configured as or otherwise support a means for transmitting a message indicating whether the UE is to transmit the energy-providing transmission to the energy-harvesting device to power on the energy-harvesting device.

In some examples, the set of resources includes one or more uplink-configured slots, one or more downlink-configured slots, or a combination thereof for the communications between the UE and the energy-harvesting device.

In some examples, the energy-harvesting communication component 1245 may be configured as or otherwise support a means for transmitting the energy-providing transmission to power on the energy-harvesting device prior to the set of resources, where the network entity transmits the energy-providing transmission in a downlink configured slot, an uplink configured slot, or both.

In some examples, the energy-harvesting communication component 1245 may be configured as or otherwise support a means for receiving a data signal from the energy-harvesting device, where the network entity receives the data signal in a downlink configured slot, an uplink configured slot, or both.

In some examples, the energy-harvesting communication component 1245 may be configured as or otherwise support a means for transmitting a data signal to the energy-harvesting device, where the network entity transmits the data signal in a downlink configured slot, an uplink configured slot, or both.

In some examples, the grant is an uplink grant or a downlink grant pertaining to the communications between the UE and the energy-harvesting device.

In some examples, the network entity configures the UE communicate with the energy-harvesting device in accordance with time division duplexing, frequency division duplexing, or a combination thereof.

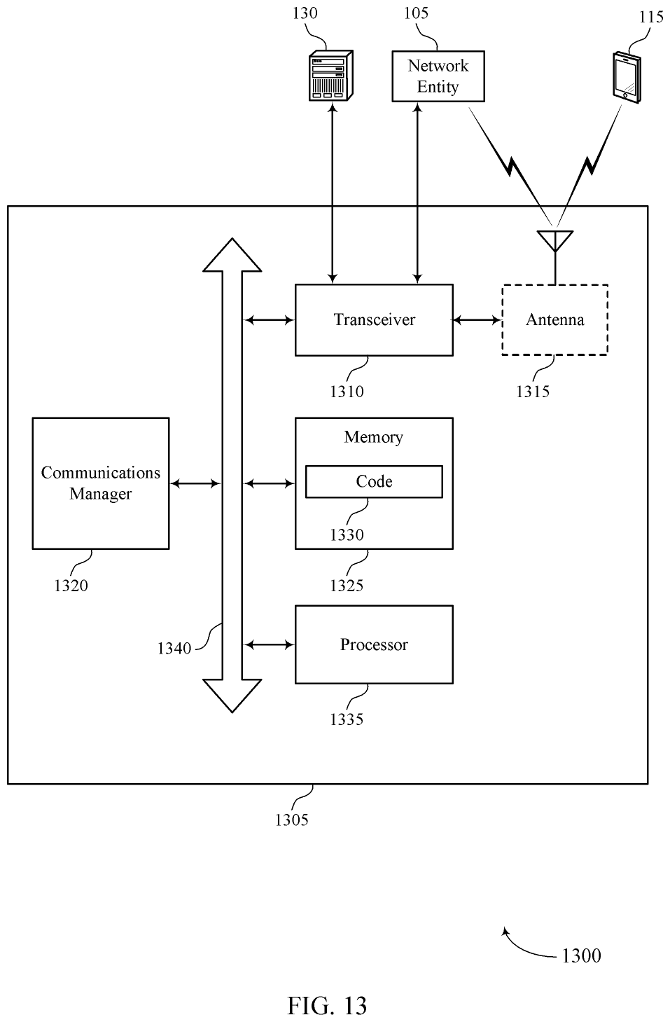

FIG. 13 shows a diagram of a system 1300 including a device 1305 that supports techniques for performing passive internet of things communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for performing passive internet of things communications). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting a grant that allocates a set of resources for use by a UE. The communications manager 1320 may be configured as or otherwise support a means for transmitting an indication that the grant transmitted to the UE pertains to communications between the UE and an energy-harvesting device, where the communications include at least one of an energy-providing transmission to the energy- harvesting device, a data transmission to the energy-harvesting device, or a data reception from the energy-harvesting device.

By including or configuring the communications manager 1320 in accordance with examples as described herein, the device 1305 may support techniques for reduced power consumption and more efficient utilization of communication resources, for example, by receiving an indication allowing the device 1305 to be aware of a wave form and modulation/demodulation scheme to adopt for communications with an energy-harvesting device in accordance with a received resource grant, supporting increased communication reliability, increased throughput and data rates, and reduced latency, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for performing passive internet of things communications as described herein, or the processor 1335 and the memory 1325 may be otherwise configured to perform or support such operations.

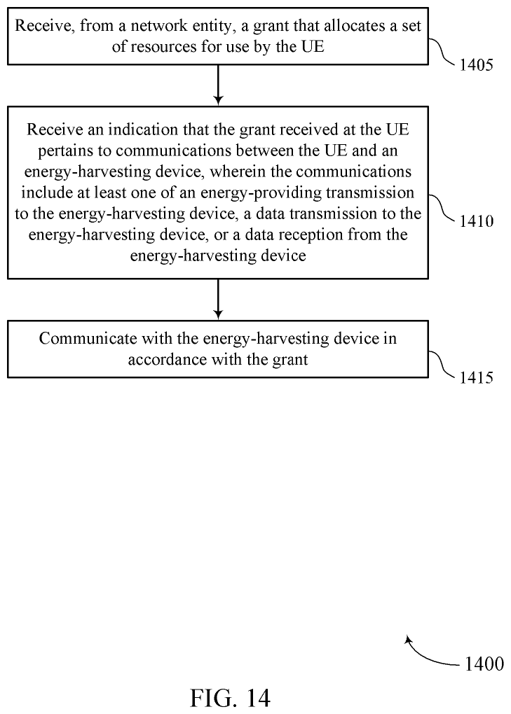

FIG. 14 shows a flowchart illustrating a method 1400 that supports techniques for performing passive internet of things communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a grant that allocates a set of resources for use by the UE. The operations of 1405 may be performed in accordance with examples as disclosed herein. In some examples, aspects of the operations of 1405 may be performed by a grant reception component 825 as described with reference to FIG. 8.

At 1410, the method may include receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device. The operations of 1410 may be performed in accordance with examples as disclosed herein. In some examples, aspects of the operations of 1410 may be performed by an energy-harvesting indication component 830 as described with reference to FIG. 8.

At 1415, the method may include communicating with the energy-harvesting device in accordance with the grant. The operations of 1415 may be performed in accordance with examples as disclosed herein. In some examples, aspects of the operations of 1415 may be performed by an energy-harvesting communication component 835 as described with reference to FIG. 8.

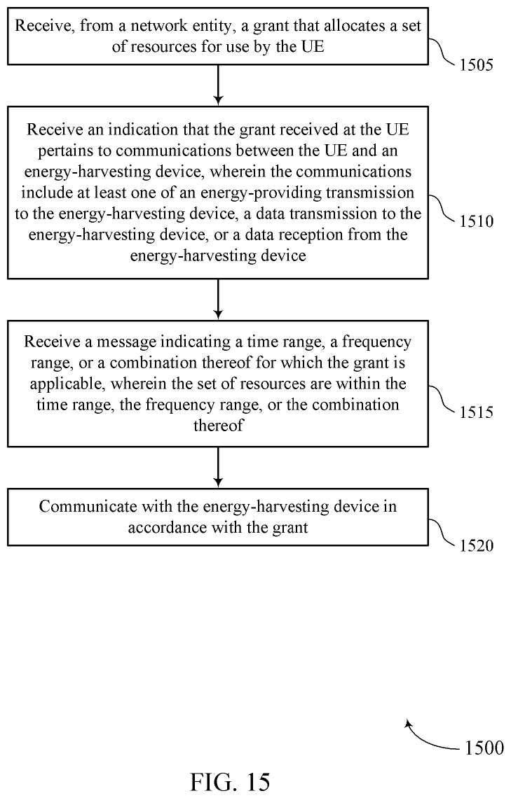

FIG. 15 shows a flowchart illustrating a method 1500 that supports techniques for performing passive internet of things communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a grant that allocates a set of resources for use by the UE. The operations of 1505 may be performed in accordance with examples as disclosed herein. In some examples, aspects of the operations of 1505 may be performed by a grant reception component 825 as described with reference to FIG. 8.

At 1510, the method may include receiving an indication that the grant received at the UE pertains to communications between the UE and an energy-harvesting device, where the communications include at least one of an energy-providing transmission to the energy-harvesting device, a data transmission to the energy-harvesting device, or a data reception from the energy-harvesting device. The operations of 1510 may be performed in accordance with examples as disclosed herein. In some examples, aspects of the operations of 1510 may be performed by an energy-harvesting indication component 830 as described with reference to FIG. 8.

At 1515, the method may include receiving a message indicating a time range, a frequency range, or a combination thereof for which the grant is applicable, where the set of resources are within the time range, the frequency range, or the combination thereof. The operations of 1515 may be performed in accordance with examples as disclosed herein. In some examples, aspects of the operations of 1515 may be performed by a resource message component 845 as described with reference to FIG. 8.

At 1520, the method may include communicating with the energy-harvesting device in accordance with the grant. The operations of 1520 may be performed in accordance with examples as disclosed herein. In some examples, aspects of the operations of 1520 may be performed by an energy-harvesting communication component 835 as described with reference to FIG. 8.

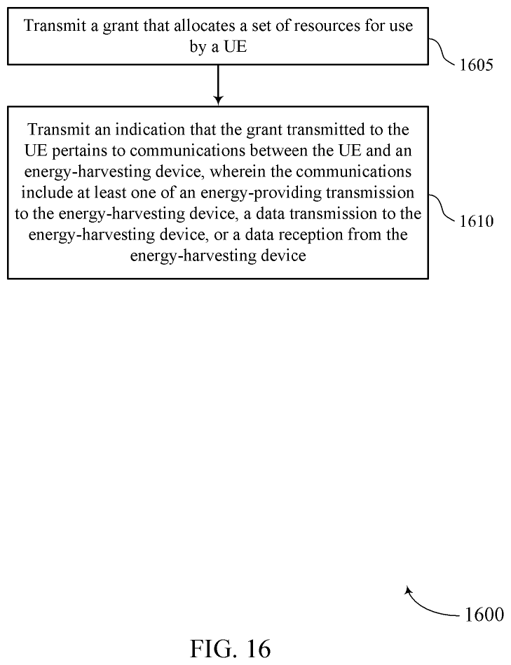

FIG. 16 shows a flowchart illustrating a method 1600 that supports techniques for performing passive internet of things communications in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a grant that allocates a set of resources for use by a UE. The operations of 1605 may be performed in accordance with examples as disclosed herein. In some examples, aspects of the operations of 1605 may be performed by a grant transmission component 1225 as described with reference to FIG. 12.

At 1610, the method may include transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device. The operations of 1610 may be performed in accordance with examples as disclosed herein. In some examples, aspects of the operations of 1610 may be performed by an energy-harvesting indication component 1230 as described with reference to FIG. 12.

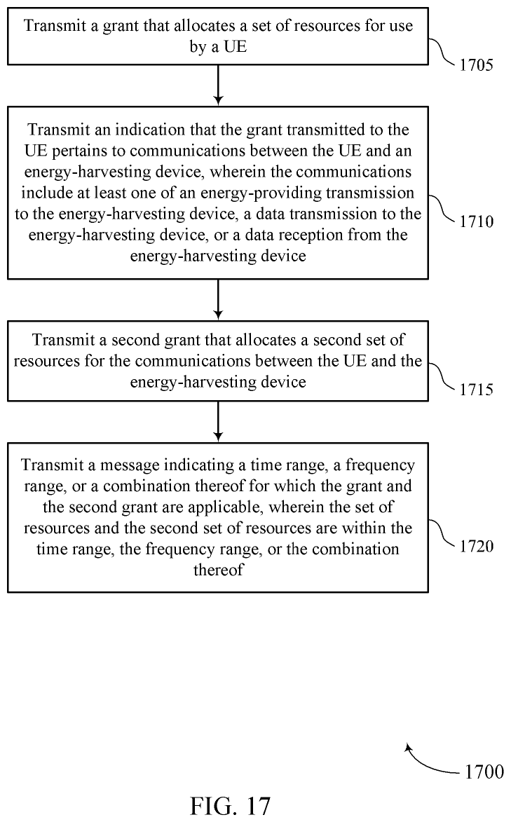

FIG. 17 shows a flowchart illustrating a method 1700 that supports techniques for performing passive internet of things communications in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a grant that allocates a set of resources for use by a UE. The operations of 1705 may be performed in accordance with examples as disclosed herein. In some examples, aspects of the operations of 1705 may be performed by a grant transmission component 1225 as described with reference to FIG. 12.

At 1710, the method may include transmitting an indication that the grant transmitted to the UE pertains to communications between the UE and an energy-harvesting device, where the communications include at least one of an energy-providing transmission to the energy-harvesting device, a data transmission to the energy-harvesting device, or a data reception from the energy-harvesting device. The operations of 1710 may be performed in accordance with examples as disclosed herein. In some examples, aspects of the operations of 1710 may be performed by an energy-harvesting indication component 1230 as described with reference to FIG. 12.

At 1715, the method may include transmitting a second grant that allocates a second set of resources for the communications between the UE and the energy-harvesting device. The operations of 1715 may be performed in accordance with examples as disclosed herein. In some examples, aspects of the operations of 1715 may be performed by a grant transmission component 1225 as described with reference to FIG. 12.

At 1720, the method may include transmitting a message indicating a time range, a frequency range, or a combination thereof for which the grant and the second grant are applicable, where the set of resources and the second set of resources are within the time range, the frequency range, or the combination thereof. The operations of 1720 may be performed in accordance with examples as disclosed herein. In some examples, aspects of the operations of 1720 may be performed by a resource message component 1235 as described with reference to FIG. 12.

The following provides an overview of aspects of the present disclosure:

Aspect 1: A method for wireless communications at a UE, comprising: receiving, from a network entity, a grant that allocates a set of resources for use by the UE; receiving an indication that the grant received at the UE pertains to communications between the UE and an energy-harvesting device, wherein the communications include at least one of an energy-providing transmission to the energy-harvesting device, a data transmission to the energy-harvesting device, or a data reception from the energy-harvesting device; and communicating with the energy-harvesting device in accordance with the grant.

Aspect 2: The method of aspect 1, wherein receiving the indication further comprises: receiving a message that explicitly indicates that the grant pertains to the communications between the UE and the energy-harvesting device, wherein the message is a radio resource control message, a medium access control (MAC) control element (MAC-CE) message, or downlink control information message.

Aspect 3: The method of any of aspects 1 through 2, wherein receiving the indication further comprises: receiving a message indicative of a plurality of resources dedicated for energy-harvesting communications; and identifying that the grant pertains to the communications between the UE and the energy-harvesting device based at least in part on the plurality of resources comprising the set of resources.

Aspect 4: The method of any of aspects 1 through 3, further comprising: receiving a message indicating a time range, a frequency range, or a combination thereof for which the grant is applicable, wherein the set of resources are within the time range, the frequency range, or the combination thereof.

Aspect 5: The method of aspect 4, wherein the message is a radio resource control message, a medium access control (MAC) control element (MAC-CE) message, or downlink control information message.

Aspect 6: The method of any of aspects 1 through 5, wherein the set of resources pertaining to the communications between the UE and the energy-harvesting device comprises a duration greater than 14 symbols.

Aspect 7: The method of any of aspects 1 through 6, further comprising: receiving, from the network entity, a second grant that allocates a second set of resources for the communications between the UE and the energy-harvesting device; and receiving a message indicating a time range, a frequency range, or a combination thereof for which the grant and the second grant are applicable, wherein the set of resources and the second set of resources are within the time range, the frequency range, or the combination thereof.

Aspect 8: The method of aspect 7, wherein the set of resources and the second set of resources are adjacent in the time range.

Aspect 9: The method of any of aspects 7 through 8, wherein a set of frequency resources of the set of resources is different from a second set of frequency resources of the second set of resources.

Aspect 10: The method of any of aspects 7 through 9, wherein the message is a radio resource control message, a medium access control (MAC) control element (MAC-CE) message, or downlink control information message.

Aspect 11: The method of any of aspects 1 through 10, further comprising: receiving a message indicating whether the UE is to transmit the energy-providing transmission to the energy-harvesting device to power on the energy-harvesting device.

Aspect 12: The method of any of aspects 1 through 11, wherein the set of resources include one or more uplink-configured slots, one or more downlink-configured slots, or a combination thereof for the communications between the UE and the energy-harvesting device.

Aspect 13: The method of any of aspects 1 through 12, wherein communicating with the energy-harvesting device further comprises: transmitting, to the energy-harvesting device, the energy-providing transmission to power on the energy-harvesting device in accordance with the grant, wherein the UE transmits the energy-providing transmission in a downlink configured slot, or an uplink configured slot, or both.

Aspect 14: The method of aspect 13, wherein the UE transmits the energy-providing transmission to the energy-harvesting device in one or more resources of the set of resources adjacent to a data signal transmitted to or received from the energy-harvesting device.

Aspect 15: The method of any of aspects 1 through 14, wherein communicating with the energy-harvesting device further comprises: receiving, from the energy-harvesting device, a data signal in accordance with the grant, wherein the UE receives the data signal in a downlink configured slot, an uplink configured slot, or both.

Aspect 16: The method of any of aspects 1 through 15, wherein communicating with the energy-harvesting device further comprises: transmitting, to the energy-harvesting device, a data signal in accordance with the grant, wherein the UE transmits the data signal in a downlink configured slot, an uplink configured slot, or both.

Aspect 17: The method of any of aspects 1 through 16, wherein the grant is an uplink grant or a downlink grant pertaining to the communications between the UE and the energy-harvesting device.

Aspect 18: The method of any of aspects 1 through 17, wherein the UE communicates with the energy-harvesting device in accordance with time division duplexing, frequency division duplexing, or a combination thereof.

Aspect 19: A method for wireless communications at a network entity, comprising: transmitting a grant that allocates a set of resources for use by a UE; and transmitting an indication that the grant transmitted to the UE pertains to communications between the UE and an energy-harvesting device, wherein the communications include at least one of an energy-providing transmission to the energy-harvesting device, a data transmission to the energy-harvesting device, or a data reception from the energy-harvesting device.

Aspect 20: The method of aspect 19, wherein transmitting the indication further comprises: transmitting a message that explicitly indicates that the grant pertains to the communications between the UE and the energy-harvesting device, wherein the message is a radio resource control message, a medium access control (MAC) control element (MAC-CE) message, or downlink control information message.

Aspect 21: The method of any of aspects 19 through 20, wherein transmitting the indication further comprises: transmitting a message indicative of a plurality of resources dedicated for energy-harvesting communications, wherein the set of resources implicitly indicates that the grant pertains to the communications between the UE and the energy-harvesting device based at least in part on the set of resources being included in the plurality of resources.

Aspect 22: The method of any of aspects 19 through 21, further comprising: transmitting a message indicating a time range, a frequency range, or a combination thereof for which the grant is applicable, wherein the set of resources are within the time range, the frequency range, or the combination thereof.

Aspect 23: The method of aspect 22, wherein the message is a radio resource control message, a medium access control (MAC) control element (MAC-CE) message, or downlink control information message.

Aspect 24: The method of any of aspects 19 through 23, wherein the set of resources pertaining to the communications between the UE and the energy-harvesting device comprises a duration greater than 14 symbols.

Aspect 25: The method of any of aspects 19 through 24, further comprising: transmitting a second grant that allocates a second set of resources for the communications between the UE and the energy-harvesting device; and transmitting a message indicating a time range, a frequency range, or a combination thereof for which the grant and the second grant are applicable, wherein the set of resources and the second set of resources are within the time range, the frequency range, or the combination thereof.

Aspect 26: The method of aspect 25, wherein the set of resources and the second set of resources are adjacent in the time range.

Aspect 27: The method of any of aspects 25 through 26, wherein a set of frequency resources of the set of resources is different from a second set of frequency resources of the second set of resources.

Aspect 28: The method of any of aspects 25 through 27, wherein the message is a radio resource control message, a medium access control (MAC) control element (MAC-CE) message, or downlink control information message.

Aspect 29: The method of any of aspects 19 through 28, further comprising: transmitting a message indicating whether the UE is to transmit the energy-providing transmission to the energy-harvesting device to power on the energy-harvesting device.

Aspect 30: The method of any of aspects 19 through 29, wherein the set of resources includes one or more uplink-configured slots, one or more downlink-configured slots, or a combination thereof for the communications between the UE and the energy-harvesting device.

Aspect 31: The method of any of aspects 19 through 30, further comprising: transmitting the energy-providing transmission to power on the energy-harvesting device prior to the set of resources, wherein the network entity transmits the energy-providing transmission in a downlink configured slot, an uplink configured slot, or both.

Aspect 32: The method of any of aspects 19 through 31, further comprising: receiving a data signal from the energy-harvesting device, wherein the network entity receives the data signal in a downlink configured slot, an uplink configured slot, or both.

Aspect 33: The method of any of aspects 19 through 32, further comprising: transmitting a data signal to the energy-harvesting device, wherein the network entity transmits the data signal in a downlink configured slot, an uplink configured slot, or both.

Aspect 34: The method of any of aspects 19 through 33, wherein the grant is an uplink grant or a downlink grant pertaining to the communications between the UE and the energy-harvesting device.

Aspect 35: The method of any of aspects 19 through 34, wherein the network entity configures the UE communicate with the energy-harvesting device in accordance with time division duplexing, frequency division duplexing, or a combination thereof.

Aspect 36: An apparatus for wireless communications at a UE, comprising a processor; memory coupled with the processor; and instructions stored in the memory and executable by the processor to cause the apparatus to perform a method of any of aspects 1 through 18.

Aspect 37: An apparatus for wireless communications at a UE, comprising at least one means for performing a method of any of aspects 1 through 18.

Aspect 38: A non-transitory computer-readable medium storing code for wireless communications at a UE, the code comprising instructions executable by a processor to perform a method of any of aspects 1 through 18.

Aspect 39: An apparatus for wireless communications at a network entity, comprising a processor; memory coupled with the processor; and instructions stored in the memory and executable by the processor to cause the apparatus to perform a method of any of aspects 19 through 35.

Aspect 40: An apparatus for wireless communications at a network entity, comprising at least one means for performing a method of any of aspects 19 through 35.

Aspect 41: A non-transitory computer-readable medium storing code for wireless communications at a network entity, the code comprising instructions executable by a processor to perform a method of any of aspects 19 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a network entity, a grant that allocates a set of resources for use by the UE;
receiving an indication that the grant received at the UE pertains to communications between the UE and an energy-harvesting device, wherein the communications include at least one of an energy-providing transmission to the energy-harvesting device, a data transmission to the energy-harvesting device, or a data reception from the energy-harvesting device; and
communicating with the energy-harvesting device in accordance with the grant.

2. The method of claim 1, wherein receiving the indication further comprises:
receiving a message that explicitly indicates that the grant pertains to the communications between the UE and the energy-harvesting device, wherein the message is a radio resource control message, a medium access control (MAC) control element (MAC-CE) message, or downlink control information message.

3. The method of claim 1, wherein receiving the indication further comprises:
receiving a message indicative of a plurality of resources dedicated for energy-harvesting communications; and
identifying that the grant pertains to the communications between the UE and the energy-harvesting device based at least in part on the plurality of resources comprising the set of resources.

4. The method of claim 1, further comprising:
receiving a message indicating a time range, a frequency range, or a combination thereof for which the grant is applicable, wherein the set of resources are within the time range, the frequency range, or the combination thereof.

5. The method of claim 1, wherein the set of resources pertaining to the communications between the UE and the energy-harvesting device comprises a duration greater than 14 symbols.

6. The method of claim 1, further comprising:
receiving, from the network entity, a second grant that allocates a second set of resources for the communications between the UE and the energy-harvesting device; and
receiving a message indicating a time range, a frequency range, or a combination thereof for which the grant and the second grant are applicable, wherein the set of resources and the second set of resources are within the time range, the frequency range, or the combination thereof.

7. The method of claim 1, further comprising:
receiving a message indicating whether the UE is to transmit the energy-providing transmission to the energy-harvesting device to power on the energy-harvesting device.

8. The method of claim 1, wherein the set of resources include one or more uplink-configured slots, one or more downlink-configured slots, or a combination thereof for the communications between the UE and the energy-harvesting device.

9. The method of claim 1, wherein communicating with the energy-harvesting device further comprises:
transmitting, to the energy-harvesting device, the energy-providing transmission to power on the energy-harvesting device in accordance with the grant, wherein the UE transmits the energy-providing transmission in a downlink configured slot, or an uplink configured slot, or both.

10. The method of claim 1, wherein communicating with the energy-harvesting device further comprises:
receiving, from the energy-harvesting device, a data signal in accordance with the grant, wherein the UE receives the data signal in a downlink configured slot, an uplink configured slot, or both.

11. The method of claim 1, wherein communicating with the energy-harvesting device further comprises:
transmitting, to the energy-harvesting device, a data signal in accordance with the grant, wherein the UE transmits the data signal in a downlink configured slot, an uplink configured slot, or both.

12. A method for wireless communications at a network entity, comprising:
transmitting a grant that allocates a set of resources for use by a user equipment (UE); and
transmitting an indication that the grant transmitted to the UE pertains to communications between the UE and an energy-harvesting device, wherein the communications include at least one of an energy-providing transmission to the energy-harvesting device, a data transmission to the energy-harvesting device, or a data reception from the energy-harvesting device.

13. The method of claim 12, further comprising:
transmitting the energy-providing transmission to power on the energy-harvesting device prior to the set of resources, wherein the network entity transmits the energy-providing transmission in a downlink configured slot, an uplink configured slot, or both.

14. The method of claim 12, further comprising:
receiving a data signal from the energy-harvesting device, wherein the network entity receives the data signal in a downlink configured slot, an uplink configured slot, or both.

15. The method of claim 12, further comprising:
transmitting a data signal to the energy-harvesting device, wherein the network entity transmits the data signal in a downlink configured slot, an uplink configured slot, or both.

16. An apparatus for wireless communications at a user equipment (UE), comprising:
a processor;
memory coupled with the processor; and
instructions stored in the memory and executable by the processor to cause the apparatus to:
receive, from a network entity, a grant that allocates a set of resources for use by the UE;
receive an indication that the grant received at the UE pertains to communications between the UE and an energy-harvesting device, wherein the communications include at least one of an energy-providing transmission to the energy-harvesting device, a data transmission to the energy-harvesting device, or a data reception from the energy-harvesting device; and
communicate with the energy-harvesting device in accordance with the grant.

17. The apparatus of claim 16, wherein the instructions to receive the indication are further executable by the processor to cause the apparatus to:
receive a message that explicitly indicates that the grant pertains to the communications between the UE and the energy-harvesting device, wherein the message is a radio resource control message, a medium access control (MAC) control element (MAC-CE) message, or downlink control information message.

18. The apparatus of claim 16, wherein the instructions to receive the indication are further executable by the processor to cause the apparatus to:
receive a message indicative of a plurality of resources dedicated for energy-harvesting communications; and
identify that the grant pertains to the communications between the UE and the energy-harvesting device based at least in part on the plurality of resources comprising the set of resources.

19. The apparatus of claim 16, wherein the instructions are further executable by the processor to cause the apparatus to:
receive a message indicating a time range, a frequency range, or a combination thereof for which the grant is applicable, wherein the set of resources are within the time range, the frequency range, or the combination thereof.

20. The apparatus of claim 16, wherein the set of resources pertaining to the communications between the UE and the energy-harvesting device comprises a duration greater than 14 symbols.

21. The apparatus of claim 16, wherein the instructions are further executable by the processor to cause the apparatus to:
receive, from the network entity, a second grant that allocates a second set of resources for the communications between the UE and the energy-harvesting device; and
receive a message indicating a time range, a frequency range, or a combination thereof for which the grant and the second grant are applicable, wherein the set of resources and the second set of resources are within the time range, the frequency range, or the combination thereof.

22. The apparatus of claim 16, wherein the instructions are further executable by the processor to cause the apparatus to:
receive a message indicating whether the UE is to transmit the energy-providing transmission to the energy-harvesting device to power on the energy-harvesting device.

23. The apparatus of claim 16, wherein the set of resources include one or more uplink-configured slots, one or more downlink-configured slots, or a combination thereof for the communications between the UE and the energy-harvesting device.

24. The apparatus of claim 16, wherein the instructions to communicate with the energy-harvesting device are further executable by the processor to cause the apparatus to:
transmit, to the energy-harvesting device, the energy-providing transmission to power on the energy-harvesting device in accordance with the grant, wherein the UE transmits the energy-providing transmission in a downlink configured slot, or an uplink configured slot, or both.

25. The apparatus of claim 16, wherein the instructions to communicate with the energy-harvesting device are further executable by the processor to cause the apparatus to:
receive, from the energy-harvesting device, a data signal in accordance with the grant, wherein the UE receives the data signal in a downlink configured slot, an uplink configured slot, or both.

26. The apparatus of claim 16, wherein the instructions to communicate with the energy-harvesting device are further executable by the processor to cause the apparatus to:
transmit, to the energy-harvesting device, a data signal in accordance with the grant, wherein the UE transmits the data signal in a downlink configured slot, an uplink configured slot, or both.

27. An apparatus for wireless communications at a network entity, comprising:
a processor;
memory coupled with the processor; and
instructions stored in the memory and executable by the processor to cause the apparatus to:
transmit a grant that allocates a set of resources for use by a user equipment (UE); and
transmit an indication that the grant transmitted to the UE pertains to communications between the UE and an energy-harvesting device, wherein the communications include at least one of an energy-providing transmission to the energy-harvesting device, a data transmission to the energy-harvesting device, or a data reception from the energy-harvesting device.

28. The apparatus of claim 27, wherein the instructions are further executable by the processor to cause the apparatus to:
transmit the energy-providing transmission to power on the energy-harvesting device prior to the set of resources, wherein the network entity transmits the energy-providing transmission in a downlink configured slot, an uplink configured slot, or both.

29. The apparatus of claim 27, wherein the instructions are further executable by the processor to cause the apparatus to:
receive a data signal from the energy-harvesting device, wherein the network entity receives the data signal in a downlink configured slot, an uplink configured slot, or both.

30. The apparatus of claim 27, wherein the instructions are further executable by the processor to cause the apparatus to:
transmit a data signal to the energy-harvesting device, wherein the network entity transmits the data signal in a downlink configured slot, an uplink configured slot, or both.
